(19) United States
(12) Patent Application Publication
(10) Pub. No.: US 2026/0293988 A1
(43) Pub. Date: Oct. 1, 2026

(54) AEROSOL-GENERATING DEVICE WITH DUAL MODE HEATING

(71) Applicant: Philip Morris Products S.A., Neuchatel (CH)

(72) Inventors: Laurent Serge LAVANANT, Evian-les-Bains (FR); Johannes Petrus Maria PIJNENBURG, Neuchâtel (CH); Jennifer Ernestine Emma PLUN, Peseux (CH); Jun Wei YIM, Colombier (CH); Jani Mikael PELTO, Nokia (FI); Ilkka Johannes RYTÖLUOTO, Nokia (FI)

(73) Assignee: Philip Morris Products S.A., Neuchatel (CH)

(21) Appl. No.: 19/477,799

(22) PCT Filed: May 2, 2024
(86) PCT No.: PCT/EP2024/062152

§ 371 Date: Oct. 23, 2025

(30) Foreign Application Priority Data
May 2, 2023 (EP) 23171165.6

(51) Int. Cl. A24F 40/465; A24F 40/485; A24F 40/51; A24F 40/53; A24F 40/57

(52) U.S. Cl. CPC A24F 40/465; A24F 40/485; A24F 40/53; A24F 40/57; A24F 40/51

(57) ABSTRACT

An aerosol-generating device to generate an aerosol from an aerosol-forming substrate is provided, the device defining a cavity to receive the substrate, and an air flow path upstream of the cavity and fluidically connecting the cavity with an external environment, the device including a first heating portion at the cavity and a second heating portion in thermal contact with the air flow path upstream of the cavity, the device to heat the substrate during a usage session with reference to a stand-by target temperature and an operational target temperature, heat the substrate to the stand-by temperature during the usage session, and heat the substrate from the stand-by temperature to the operational temperature during a user puff, the substrate being allowed to cool from the operational temperature after the end of the user puff, the first and second heating portions to heat the substrate to the stand-by and operational temperatures, respectively.

The present disclosure relates to an aerosol-generating device. The present disclosure also relates to an aerosol-generating system comprising the aerosol-generating device and a method of controlling the aerosol-generating device.

Some known aerosol-generating systems comprise an aerosol-generating device and an aerosol-generating article comprising an aerosol-forming substrate. In use, the aerosol-generating device heats the aerosol-forming substrate of the aerosol-generating article to form an aerosol.

Aerosol generating articles in which an aerosol-forming substrate, such as a tobacco containing substrate, is heated rather than combusted are known in the art. Typically, in such aerosol generating articles an aerosol is generated by the transfer of heat from a heat source to an aerosol-forming substrate.

Electrically operated aerosol-generating devices, for example handheld aerosol-generating devices, may be used with such aerosol generating articles. Such electrically operated aerosol-generating devices may comprise a heating element configured to heat an aerosol-forming substrate to temperatures of several hundred degrees centigrade. This releases volatile compounds from the aerosol-forming substrate which are entrained in air drawn through the aerosol generating article. As the released compounds cool, they condense or nucleate to form an aerosol.

Several examples of aerosol-generating devices for consuming aerosol-generating articles have been disclosed in the art. Such devices include, for example, electrically heated aerosol-generating devices in which an aerosol is generated by the transfer of heat from one or more electrical heater elements of the aerosol-generating device to the aerosol-generating element of an aerosol-generating article. To this purpose, the aerosol-generating article may be partially received within a heating cavity of the aerosol-generating device, such that an upstream end of the aerosol-generating article is inserted into the cavity whereas a downstream end of the aerosol-generating article projects out of the cavity.

For example, electrically heated aerosol-generating devices have been proposed that comprise an internal heater blade which is adapted to be inserted into the aerosol-generating substrate when the aerosol-generating article is received within the heating cavity. As an alternative, heating of the aerosol-generating substrate has been accomplished using external heating, such as by way of a tubular heater element that at least partially defines the heating cavity into which the aerosol-generating article is inserted or that it otherwise coupled with a tubular element defining the heating cavity.

Inductively heatable aerosol-generating articles have also been proposed, such as for example in WO 2015/176898. These aerosol-generating articles comprise an aerosol-generating element comprising an aerosol-generating substrate, such as a tobacco-containing substrate, and a susceptor arranged within the aerosol-generating substrate. Functional coupling between the susceptor and an inductive heater element of the aerosol-generating device is achieved when the aerosol-generating article is partially received within the heating cavity of the aerosol-generating device.

Solid aerosol-generating substrates need to be heated up to temperatures sufficient to promote extraction of aerosol species (for example, nicotine and glycerine). Existing heaters are typically configured to supply heat so that the solid aerosol-generating substrate is exposed to temperatures within such ranges throughout. However, this heating set-up may have the drawback that battery efficiency of use is less than optimal. Further, this heating set-up may limit use of a solid aerosol-generating substrate to a predetermined and finite number of puffs or to a predetermined number of minutes. Additionally, maintaining a solid aerosol-generating substrate at temperatures sufficient to promote extraction of aerosol species in between puffs may also undesirably increase a risk of generating harmful and potentially harmful constituents (HPHCs).

It would be desirable to provide an aerosol-generating device adapted to at least partially address at least one of the drawbacks discussed above.

The present disclosure relates to an aerosol-generating device configured to generate an aerosol from an aerosol-forming substrate, for example during a usage session. The device may be configured to heat the aerosol-forming substrate to a stand-by temperature or maintenance temperature during the usage session. The device may be configured such that the temperature of the aerosol-forming substrate increases from the stand-by temperature when a user takes a puff, for example to an operational temperature. For example, the device may be configured to supply a thermal boost to the aerosol-forming substrate during a user puff taken during the user session. Such a configuration may allow the aerosol-forming substrate to be heated to a first temperature, for example the stand-by temperature, that is at or slightly below a temperature required to form an aerosol, and then be heated to an increased temperature, for example the operational temperature, that is above the temperature required to form an aerosol during the user puff.

By selecting an appropriate stand-by temperature, the aerosol-forming substrate can be boosted in temperature almost instantaneously to the operational temperature on application of further thermal energy to the substrate. The temperature can be allowed to drop to the stand-by temperature after a user puff.

The combination of heating to a stand-by temperature and a rapid temperature rise to an operational temperature on puffing, allows efficient harvesting of desirable components of the aerosol-forming substrate, such as nicotine, flavour components, and aerosol-formers such as Glycerin, without extensively overheating the substrate. Formation of undesirable aerosol-constituents may be reduced and an optimal harvest of the desirable components may be obtained.

An aerosol-generating device may define a cavity for receiving at least a portion of the aerosol-forming substrate. The aerosol-generating device may define an air flow path upstream of the cavity through which a user can draw air when using the device. The air flow path may connect the cavity with the external environment, for example fluidically connect the cavity and the external environment. The device may comprise a heating portion located at the cavity, for example a heating portion for directly heating the cavity. The device may comprise a second heating portion located in thermal contact with the air flow path upstream of the cavity, for example a second heating portion for directly heating the air flow path upstream of the cavity.

According to an aspect of the present invention, there is provided an aerosol-generating device configured to generate an aerosol from an aerosol-forming substrate. The device defines a cavity for receiving at least a portion of the aerosol-forming substrate, and an air flow path upstream of the cavity through which a user can draw air when using the device, the air flow path connecting the cavity with the external environment. The device further comprises a first heating portion located at the cavity. The first heating portion may comprise a heater or heating means arranged to directly heat the cavity and any contents of the cavity, whether or not air is flowing through the air flow path. The device further comprises a second heating portion located in thermal contact with the air flow path upstream of the cavity. The second heating portion may comprise a heater or heating means arranged to heat air within the air flow path upstream of the cavity.

Advantageously, the first heating portion may be used to heat an aerosol-forming substrate positioned in the cavity to a first temperature, for example a stand-by temperature, and the second heating portion may be used to boost the temperature of the aerosol-forming substrate to an operational temperature higher than the stand-by temperature when a user takes a puff.

It is noted that the cavity may be alternately termed a chamber, and the terms cavity and chamber may be used interchangeably herein to mean a part of the device for receiving at least a portion of the aerosol-forming substrate so that the substrate may be heated to generate an aerosol.

The first heating portion may comprise a heater, or heating means, that is arranged to at least partially surround the cavity. Thus, the heater, which may be termed an external heater, could be arranged to heat walls of the cavity from all sides to help provide even heating of the cavity. An external heater may be a preferred heater for heating the substrate received in the cavity as the aerosol-forming substrate can be heated to an even temperature without contact between the substrate and the heater.

The first heating portion may comprise a heater arranged in contact with walls of the cavity, for example a resistance heater arranged in contact with walls of the cavity. As an example, the first heating portion may comprise a flexible heater arranged in contact with an inner or outer surface of the cavity, for example a polyimide flexible heater arranged in contact with an inner or outer wall of the cavity. Such a heater may directly heat walls of the cavity by conduction. The cavity may be heated by radiation and convection of heat from the cavity walls or, where the heater is located within the cavity, directly from the heater itself.

An inner surface of the resistance heater, which may be in the form of a flexible sheet, may be covered or coated with a protective film. For example, the heater may be coated with a thin film having high thermal conductivity for spreading the heat generated by the first heating portion. For example, the heater may be coated with a thin film having anti-adhesion properties.

The first heating portion may comprise a heater that is located within the cavity, for example a protruding heater configured to penetrate an aerosol-forming substrate inserted into the cavity. Such a heater may provide direct contact with an aerosol-forming substrate inserted into the cavity which may improve heating efficiency.

The first heating portion may comprise an inductive heating arrangement. For example the first heating portion may comprise an inductor located external to the cavity that is configured to heat a susceptor located within the cavity, or a susceptor in contact with or forming part of the cavity walls. Thus, the cavity walls may comprise, or may be entirely formed from, a susceptor material such as a stainless steel.

A susceptor, which may also be referred to as a susceptor element, may comprise or consist of one or more susceptor materials.

Suitable susceptor materials may include but are not limited to: carbon, carbon-based materials, graphene, graphite, expanded graphite, molybdenum, silicon carbide, stainless steels, niobium, aluminium, nickel, nickel-containing compounds, titanium, and composites of metallic materials. Suitable susceptor materials may comprise a ferromagnetic material, for example, ferritic iron, a ferromagnetic alloy, such as ferromagnetic steel or stainless steel, ferromagnetic particles, and ferrite. A susceptor material may comprise more than 5 percent, preferably more than 20 percent, more preferably more than 50 percent or more than 90 percent of ferromagnetic or paramagnetic materials. Preferred susceptor materials may comprise a metal, metal alloy or carbon.

The device may comprise a capacitive-type or dielectric-type heater to heat an aerosol-forming substrate received in a cavity of the device, for example in which the device includes opposing electrodes that are fed by a high-frequency AC signal via an impedance matching circuit, to heat the substrate located in the cavity between the two opposing electrodes with microwaves.

Preferably, the first heating portion is configured to directly heat an aerosol-forming substrate received within the cavity. That is, the first heating portion may be configured or arranged to heat an aerosol-forming substrate within the cavity irrespective of whether a user is taking a puff to cause air to flow through the air flow path.

The cavity comprises an air inlet connecting the cavity with the air flow path upstream of the cavity. Thus, a user can draw on an aerosol-generating article located within the cavity and in doing so draw air through the air flow path.

Preferably, the second heating portion is located within the air flow path upstream of the cavity. The second heating portion may comprise a heater located within the airflow path upstream of the cavity, for example a resistance heater located within the air flow path upstream of the cavity. For example, the second heating portion may comprise a heater formed of at least one resistive heating element or resistive heating track. The second heating portion may comprise a resistive heating coil.

The second heating portion may comprise baffles located within the air flow path to direct air flow through the second heating portion. The baffles may form a portion of a resistive heating track.

Alternatively, or in addition, the second heating portion may comprise a heater arranged in contact with an outer surface of the second heating portion. Such a heater may comprise a heater formed of resistive heating elements or resistive heating tracks. For example, the heater may comprise rollable resistive heating tracks.

The second heating portion may comprise an inductive heating arrangement. For example, the second heating portion may comprise an inductor configured to heat a susceptor located within the air flow path upstream of the cavity. The susceptor when heated could heat air passing through the air flow path.

The second heating portion may comprise a heat exchanger. Advantageously, the second heating portion may comprise an air permeable body, for example a porous body, the air flow path being defined through the air permeable body. The porous body may be a porous plug comprising or consisting of silicon dioxide. The air permeable body may be configured to have a high internal surface area, for example by use of multiple channels or baffles that produce a convoluted air path through the air permeable body. The air permeable body, for example the porous body, may therefore act as a heat exchanger to transfer heat from the air permeable body to air passing therethrough. The air flow path through the second heating portion may have a predetermined resistance to draw (RTD), and an air permeable body may have internal air flow paths, for example internal porosity, configured to provide such a predetermined RTD.

The air permeable body may comprise an opening. The opening may located in a substantially radially central portion of the air permeable body. The opening may extend through air permeable body such that the air permeable body is tubular. The air permeable body may comprise a plurality of openings. The plurality of openings may be arranged in a radially symmetrical arrangement around the air permeable body.

The second heating portion may comprise a heating body configured for resistance heating, which may be termed Joule heating, the heating body including a polymer composite comprising a polymeric matrix and a plurality of conductive particles dispersed within the polymer matrix. Such a heating body may function both as part of the structure of the heating body and as a heating element. Thus, portions of the heating body may heat up when an electrical current is passed through those portions of the heating body. The heating body may include the porous body. The heating body may include both porous and non-porous portions.

In an example, a suitable polymer composite may comprise a polymeric matrix and a plurality of non-metallic conductive particles dispersed within the polymer matrix. For example, the plurality of non-metallic conductive particles may comprise one or more of a plurality of carbon particles, such as graphite particles, and a plurality of boron nitride particles, for example hexagonal boron nitride particles. Thus, the conductive particles may be carbon particles, or boron nitride particles, or a mixture of both. In preferred examples, the plurality of non-metallic conductive particles comprises at least one of expanded graphite particles and graphite nanoplatelets.

Preferably, the polymeric matrix comprises at least one of polyether ether ketone (PEEK) and a liquid crystal polymer (LCP).

The polymeric matrix may account for between 22 percent and 33 percent by weight of the polymer composite.

The non-metallic conductive particles may account for between 62 percent and 69 percent by weight of the polymer composite.

The polymer composite may further comprise at least one additive dispersed within the polymeric matrix. For example, the at least one additive may be, or comprise, carbon black.

The heating body of the second heating portion may be formed by processing particles of the polymer composite. Portions of the heating body may be formed by moulding or extruding the polymer composite. A porous body portion of the heating body is preferably formed by partially sintering particles of the polymer composite such that an air flow path is still defined though the porous body. The porous body portion may comprise a porous plug formed by sintering polymer particles to provide an air permeable body. Preferably, the polymer particles that are sintered to form the porous body portion or porous plug have a number average particle diameter of less than 1000 micrometres, for example less than 800 micrometres, for example between 50 micrometres and 600 micrometres. Preferably, a transverse cross-sectional porosity of the porous plug is greater than 15 percent and less than 45 percent. Preferably, a total pore volume of the porous plug is between 0.5 cubic centimetres and 5 cubic centimetres, for example between 2 cubic centimetres and 3.5 cubic centimetres. Preferably, the porous plug provides a resistance to draw of between 10 mm H₂O and 40 mm H₂O, for example about 15 mm H₂O or about 20 mm H₂O. The second heating portion may comprise an inductor coil extending around at least a portion of the heating body. For example, a power supply and a controller may be connected to the inductor coil and configured to provide a varying electric current to the inductor coil such that, in use, the inductor coil generates a varying magnetic field. The inductor coil may be positioned in direct contact with an outer surface of the heating body.

Alternatively, or in addition, the heating body may comprise or consist of a ceramic material, for example, alumina or zirconia. Advantageously, a ceramic material may provide a high thermal conductivity

Preferably, the aerosol-generating device is configured to generate an aerosol from an aerosol-forming substrate during a usage session having a usage session start and a usage session end. Advantageously, the device may be configured to distinguish between a puff period and a non-puff period. A puff period may be defined as any period during the usage session in which a user is actively taking a puff. A non-puff period may be defined as any period during the usage session when a user is not actively taking a puff.

The device is preferably configured to heat the aerosol-forming substrate during the usage session with reference to two different target temperatures, a stand-by or maintenance target temperature and an operational target temperature. The stand-by target temperature is preferably a temperature that is greater than room temperature and the operational target temperature is higher than the stand-by target temperature. Preferably, signals from the flow detector, for example the pressure sensor, are used to control the temperature to either the stand-by target temperature or the operational target temperature.

Thus, the device is preferably configured to control the temperature of the aerosol-forming substrate with reference to the stand-by target temperature during non-puff periods and with respect to the operational target temperature during puff periods. The result is the during non-puff periods the temperature of the substrate is maintained consistently at the stand-by target temperature. Once the start of a user puff is detected, the temperature rises to the operational target temperature, and after the user puff has ended the temperature is allowed to drop to the stand-by target temperature once more.

Thus, the invention may provide an aerosol-generating device configured to generate an aerosol from an aerosol-forming substrate during a usage session, for example an aerosol-generating device as described above, in which the device is configured to heat the aerosol-forming substrate during the usage session with reference to two different target temperatures, a stand-by target temperature and an operational target temperature, the stand-by target temperature being a temperature greater than room temperature and the operational target temperature being higher than the stand-by target temperature, in which the device is configured to heat the aerosol-forming substrate to the stand-by temperature during the usage session, and in which the device is further configured to heat the aerosol-forming substrate from the stand-by target temperature to the operational target temperature during a user puff undertaken during the usage session, the aerosol-forming substrate being allowed to cool from the operational target temperature after the end of the user puff.

Thus, according to some aspects of the invention, an aerosol-generating device may be provided that is configured to generate an aerosol from an aerosol-forming substrate during a usage session, for example an aerosol-generating device as described above, in which the device is configured to heat the aerosol-forming substrate during the usage session with reference to two different target temperatures, a stand-by target temperature and an operational target temperature, the stand-by target temperature being a temperature greater than room temperature and the operational target temperature being higher than the stand-by target temperature, in which a puff period is defined as any period during the usage session in which a user is actively taking a puff, and a non-puff period is defined as any period during the usage session when a user is not actively taking a puff, and in which the device is configured to operate in a stand-by mode during non-puff periods, temperature of the aerosol-forming substrate being controlled with reference to the stand-by target temperature when operating in the stand-by mode, and in which the device is configured to operate in an operational mode during puff periods, the temperature of the aerosol-forming substrate being controlled with reference to the operational target temperature when operating in the operational mode.

Thus, according to some aspects of the invention, an aerosol-generating device may be provided that is configured to generate an aerosol from an aerosol-forming substrate during a usage session, for example an aerosol-generating device as described above, in which the device is configured to heat the aerosol-forming substrate during the usage session according to a stand-by mode or an operational mode, in which during the stand-by mode the temperature of the aerosol-forming substrate is controlled with reference to a stand-by target temperature, and during the operational mode the temperature of the aerosol-forming substrate is controlled with reference to an operational target temperature, the stand-by target temperature being a temperature greater than room temperature and the operational target temperature being a temperature higher than the stand-by target temperature, in which operation of the device changes from the stand-by mode to the operational mode when a user starts a puff and from the operational mode to the stand-by mode when the user ends the puff.

Thus, according to some aspects of the invention, an aerosol-generating device may be provided that is configured to supply energy to heat the aerosol-forming substrate to the stand-by temperature and a second heating portion configured to heat the aerosol-forming substrate to the operational temperature during user puffs. In specific examples, both the first heating portion and the second heating portion are actuated at a start of a usage session, the first heating portion being configured to directly heat an aerosol-forming substrate received in the cavity and the second heating portion configured to heat air drawn into the air flow path by a user puff.

An aerosol-generating device may be configured to detect a user puff. The device may be further configured such that power is only supplied to the second heating portion during a user puff and no power is supplied when a user is not taking a puff. Alternatively, power may be supplied continuously to the second heating portion, but power supplied to the second heating portion may be increased during a user puff.

An aerosol-generating device may comprise an air flow detector for detecting a user puff. For example, the device may comprise a pressure sensor located in the airflow path, for example in the air flow path upstream of the cavity. The device may be configured to use signals from the flow detector or flow detection means, for example the pressure sensor, to detect one or more user puffs taken during the usage session.

Where a device is configured to detect a user puff using a sensor such as a pressure sensor located within the air flow path, it may be preferable that the air flow path upstream of the cavity acts as a flow restrictor or comprises a flow restrictor. For example, a flow restrictor may comprise a mechanical element such as an orifice plate located within the air flow path. As a further example, a portion of the air flow path may be sufficiently narrow to act as a flow restrictor. A flow restriction may increase velocity of air drawn through the air flow path and may create a pressure drop. A flow restriction may enhance a pressure drop created when a user draws air through the air flow path. Thus, a flow restriction may increase the sensitivity of puff detection. For example, an increased pressure drop associated with a flow restriction within a portion of the air-flow path may improve the ability of a pressure sensor to accurately detect a user puff.

The flow restrictor may be a variable flow restrictor. For example the flow restrictor may be an adjustable valve, for example a user actuatable valve means such as an adjustable screw. The use of such a variable flow restrictor may allow a user to optimise the air-flow through the device to account for different types of aerosol-generating article. The restriction may be varied to optimise puff detection for a particular user.

A portion of the air flow path upstream of the cavity may have a cross-sectional area of less than 3 mm², for example less than 2 mm², or less than 1.5 mm², or less than 0.5 mm². A portion of the air flow path upstream of the cavity may have a cross-sectional area of less than 0.5 mm², for example less than 0.4 mm², or less than 0.2 mm^{2,} or less than 0.1 mm² . Such cross-sectional areas may provide a flow restriction, for example to amplify sensitivity of a pressure sensor to air flow changes associated with a user puff.

A resistance to draw of the flow restriction causes a pressure drop that can be detected by a pressure sensor. Thus, it may be desirable for a flow restriction upstream of the pressure sensor to provide a sufficient resistance to draw to cause a detectable pressure drop. The resistance to draw may be more important than the absolute cross-sectional area of the air flow path. For example, an air flow path comprising multiple small inlets may provide a greater resistance to draw, and therefore greater pressure drop downstream of the inlets, than an air flow path having a single inlet of the same cross-sectional area as the multiple inlets combined.

The air flow path upstream of the cavity may preferably have a resistance to draw (RTD) of greater than 10 mm H₂O. This RTD can provide a detectable pressure drop for a pressure sensor. For example, the RTD may be between 10 mm H₂O and 50 mm H₂O. For example, a portion of the air flow path comprising the flow restrictor may provide a resistance to draw (RTD) of between 10 mm H₂O and 50 mm H₂O.

As used herein, resistance to draw is measured in accordance with conditions set out in ISO 6565:2015. Thus, the resistance to draw of the air flow path between the inlet and the pressure sensor, when measured in accordance with the conditions set out in ISO 6565:2015, may be at least about 70 pascals (Pa), for example at least about 80 Pa, or at least about 90 Pa, or at least about 100 Pa. 100 Pa is about 10 millimetres of water gauge (mmH₂O). The RTD may be at least 150 Pa, or at least 200 Pa, for example at least about 450 Pa. 450 Pa is about 45 millimetres of water gauge (mmH₂O). The conditions set out in ISO 6565:2015 comprise an outlet flowrate of 17.5 millilitres per second, an ambient temperature of 22 degrees Celsius, and a relative ambient humidity of 60 percent.

The flow restrictor may be any suitable flow restriction that causes a pressure drop in the airflow path that is measurable by the pressure sensor when a user takes a puff on the aerosol-generating device.

In some preferred embodiments, the flow restrictor is provided by the inlet of the airflow path. The inlet may comprise a plurality of inlets. For example, the inlet may comprise between one and thirty inlets, or between four and twenty five inlets, or between seven and twenty openings. In some embodiments, the inlet may comprise between fourteen and seventeen inlets. The inlet or plurality of inlets may have any suitable size and shape to provide the desired resistance to draw and pressure drop in the airflow path when a user takes a puff on the aerosol-generating device. For example, in some preferred embodiments, the inlet may comprise between 5 and 25 inlets, more preferably between 14 and 17 inlets, each inlet having a substantially circular cross-sectional shape with a diameter in a range of about 0.3 to 1.2 millimeters, more preferably about 0.5 millimetres.

Preferably, the inlet, or the plurality of inlets, is arranged to enable ambient air to be drawn into the aerosol-generating device. The inlet or the plurality of inlets may have a combined total cross-sectional area of less than the cross-sectional area of the airflow path immediately after the inlet or inlets.

The pressure sensor may be located at the flow restrictor and may detect a drop in pressure associated with the increased velocity of air through the flow restriction during a user puff. The pressure sensor may be located upstream of the cavity but downstream of the flow restrictor. The flow restrictor enhances a pressure drop associated with a user puff and may increase sensitivity of the pressure sensor and improve accuracy of puff detection.

The air flow path upstream of the cavity may comprise a flow restrictor and may further comprise an expansion zone downstream of the flow restrictor. Preferably, the pressure sensor is located at or in the expansion zone. This configuration may optimally amplify the sensitivity of the pressure sensor. For example, the air flow path may be at least partially defined by a channel having a first portion having a first cross-sectional area and a second portion having a second cross-sectional area greater than the first cross-sectional area. The first portion forms the flow restrictor and, preferably, the pressure sensor is located at the second portion.

The air flow path upstream of the cavity further may further comprise a third portion having a third cross-sectional area, the third cross-sectional area being less than the second cross-sectional area, for example in which the third portion forms a second flow restriction.

The air flow path upstream of the cavity may comprise a first flow restrictor and a second flow restrictor, the pressure sensor being located between the first flow restrictor and the second flow restrictor, for example in which the pressure sensor is located in an expansion portion or expansion chamber located between the first flow restrictor and the second flow restrictor. The second flow restrictor may advantageously help prevent blow back of vapour from the vapour chamber, which could potentially contaminate the pressure sensor.

The aerosol-generating device may comprise multiple air inlets for allow air to flow into the cavity. For example device may comprise a plurality of air inlets, each air inlet associated with an air flow path leading to the cavity. A pressure sensor may be located in one of these air flow paths. More than one of the air flow paths may be associated with a pressure sensor. This may help build some redundancy into the system.

Multiple air inlets may feed the air flow path into an expansion cavity located downstream of the air inlets and upstream of the cavity. The pressure sensor is preferably located in the expansion cavity. Preferably, a total cross-sectional area of the multiple air inlets is less than the cross-sectional area of the expansion cavity. Thus, the air flow path through multiple inlets upstream of the expansion cavity containing the pressure sensor may provide a resistance to draw (RTD) of greater than 10 mm H₂O, for example greater than 20 H₂O, or greater than 30 H₂O, preferably between 10 mm H₂O and 50 mm H₂O.

The aerosol-generating device may comprise a second pressure sensor configured to sense ambient pressure. An ambient pressure sensor may provide a signal that is representative of background pressure to help improve accuracy of the puff detection, serving as a reference or baseline signal. For example, small pressure changes naturally occur with weather changes, or if a user changes their altitude by, for example, walking up stairs, or if there is a sudden noise. A measurement of background pressure may help prevent false readings of user puffs.

The air flow path may be defined, in part, by a channel running adjacent to, or in contact with, a heater. For example the air flow path may run in thermal contact with a heater configured to heat aerosol-forming substrate located within the cavity. Incoming air flow may, therefore, be partially heated by the same heater that is configured to heat the substrate within the cavity. This may capture some heat energy that would otherwise be lost. By allowing the air flow path to be heated in this manner, less energy may be required to achieve the desired temperatures at the aerosol-forming substrate.

The device may comprise a pressure sensor such as an absolute pressure sensor, for example a piezoresistive pressure sensor. The pressure sensor may comprise any suitable type of pressure sensor. The pressure sensor may be an absolute pressure sensor, configured to determine the absolute pressure at a position in the airflow path. The pressure sensor may be a gauge pressure sensor, configured to detect the relative pressure at a location in the airflow path compared to an ambient pressure adjacent the aerosol-generating device. The pressure sensor may be a differential pressure sensor, configured to detect a difference in pressure between a first position in the airflow path and a second position in the airflow path. The pressure sensor may be a capacitive pressure sensor. The pressure sensor may be a piezoresistive pressure sensor. The pressure sensor may be a strain gauge. Preferably, the pressure sensor is a microelectronic mechanical systems (MEMS) pressure sensor. Advantageously, a MEMS pressure senso may be small enough to fit into the aerosol-generating device without significantly increasing the size of the aerosol-generating device. A non-limiting example of a suitable absolute pressure sensor is the MEMS nano pressure sensor LPS22HBTR, manufactured by STMicroelectronics, which has an operating pressure of between about 26 kilopascals (kPa) and about 126 kilopascals (kPa), and dimensions of 2 millimetres by 2 millimetres by 0.76 millimetres.

An aerosol-generating device as disclosed herein may be configured to heat the aerosol-forming substrate during a usage session with reference to two different target temperatures, a stand-by target temperature and an operational target temperature. The stand-by target temperature is a temperature greater than room temperature and the operational target temperature is higher than the stand-by target temperature. The device may be configured to heat the aerosol-forming substrate to the stand-by temperature during the usage session, and may be further configured to heat the aerosol-forming substrate from the stand-by target temperature to the operational target temperature during a user puff undertaken during the usage session. The aerosol-forming substrate is preferably allowed to cool from the operational target temperature after the end of the user puff.

A stand-by target temperature is preferably a temperature that is too low to evolve a substantial aerosol from the aerosol-forming substrate. In other words, the stand-by temperature may be below an effective aerosolization temperature of the aerosol-forming materials or ingredients of the substrate. For example, the stand-by target temperature may be lower than a vaporisation temperature or effective boiling point of the aerosol-former or aerosol-former mixture of the aerosol-forming substrate. For example, the stand-by target temperature may be set to be lower than the boiling point of propylene glycol, or lower than the boiling point of glycerol, or lower than the boiling point of the specific mixture of propylene glycol and glycerol used as an aerosol-former in the aerosol-forming substrate. The stand-by temperature may be alternatively termed a maintenance temperature.

The stand-by target temperature may be lower than 250° C., for example lower than 230° C., for example lower than 210° C., preferably lower than 200° C., for example lower than 180° C., or lower than 160° C. The stand-by target temperature may be a temperature of between 50° C. and 250° C., for example between 80° C. and 200° C., for example between 100° C. and 180° C.

An operational target temperature is preferably a temperature that is high enough to evolve an aerosol from the aerosol-forming substrate. In other words, the operational temperature may be above an effective aerosolization temperature for the substrate. For example, the operational target temperature may be higher than an effective boiling point of the aerosol-former or aerosol-former mixture of the aerosol-forming substrate, for example higher than the boiling point of propylene glycol, or higher than the boiling point of glycerol, or higher than the boiling point of the specific mixture of propylene glycol and glycerol used as an aerosol-former in the aerosol-forming substrate.

The operational target temperature may be greater than 160° C., for example greater than 180° C., or greater than 200° C., or greater than 250° C., for example greater than 280° C., or greater than 300° C., or greater than 320° C., or greater than 340 °C. The operational target temperature may be a temperature of between 160° C. and 400° C., for example between 180° C. and 340° C., for example between 220° C. and 300° C.

The stand-by target temperature may be constant throughout the duration of the usage session. Alternatively, the stand-by target temperature may vary over the duration of the usage session. That is, the stand-by target temperature may evolve over the course of a usage session to account for depletion of aerosol-forming components as the user puffs during the usage session.

The operational target temperature may be constant throughout the duration of the usage session. Alternatively, the operational target temperature may vary over the duration of the usage session. The operational target temperature may vary from puff to puff. A variation in operational target temperature, for example an increase in operational target temperature, may help optimise aerosol delivery from an aerosol forming substrate that becomes depleted in aerosol-forming components over the course of a usage session.

Preferably, the usage session has a usage session start and a usage session end. Preferably, the aerosol-forming substrate is heated to the stand-by target temperature at the usage session start and maintained at or above the stand-by target temperature over a duration of the usage session until the usage session end. The usage session may be defined between a usage session start and a usage session end, a puff period may be defined as any period during the usage session in which a user is actively taking a puff, and a non-puff period may be defined as any period during the usage session when a user is not actively taking a puff, and the temperature of the aerosol-forming substrate may be controlled with reference to the stand-by target temperature during a non-puff period and with respect to the operational target temperature during a puff period.

Preferably, each of one or more puffs taken during the usage session has a puff start and a puff end, and in which the period between the puff start and the puff end is defined as a puff period.

The usage session may have a usage session duration, for example a predetermined duration set with reference to time, or with reference to a usage parameter, or with reference to both time and a usage parameter. A usage parameter may preferably be a parameter selected from the list consisting of, number of user puffs taken during the usage session, volume of aerosol generated during the usage session, and power supplied to a heater during the usage session.

The device is preferably configured to detect one or more user puffs taken during the usage session. The device is configured to detect the start of a user puff taken during the usage session, for example each user puff taken during the usage session. The device is preferably configured to detect the end of a user puff taken during the usage session, for example each user puff taken during the usage session. Thus, the device may be configured to determine the duration of a user puff taken during the usage session, for example each user puff taken during the usage session.

Advantageously, the device may be configured to characterise a user puff taken during the usage session, for example each puff taken during the usage session. For example, the device may be configured to determine the volume of aerosol generated during the user puff taken during the usage session, for example each user puff taken during the usage session.

In some embodiments, the aerosol-generating device may be configured to monitor a parameter indicative of aerosol generation during operation of the aerosol-generating device and to use the monitored parameter in the detection of one or more user puffs taken during the usage session. In such embodiments a puff may be detected without the need for a sensor. The monitored parameter may be analysed to identify a user puff, the user puff defined by a puff start and a puff end.

The monitored parameter may be representative of power supplied by the power supply. Analysis of the monitored parameter may comprise steps of calculating a first characteristic of the monitored parameter and analysing the first characteristic to determine a puff start and a puff stop. Analysis of the monitored parameter may further comprise steps of calculating a second characteristic of the monitored parameter and analysing both the first characteristic and the second characteristic to determine the puff start and the puff stop. A puff start may be determined when the first characteristic and the second characteristic satisfy one or more predetermined conditions. Likewise, a puff end may be determined when the first characteristic and the second characteristic satisfy one or more predetermined conditions.

In preferable examples, the first characteristic is a first moving average value of the monitored parameter computed on a first time window having a first time window duration. The second characteristic may be a second moving average value of the monitored parameter computed on a second time window having a second time window duration, the second time window duration being different to the first time window duration. A puff start may be determined when the first moving average value and the second moving average value meet a predetermined relationship with respect to each other. A suitable method of detecting a user puff by monitoring characteristics of a power signal are set out in WO2022/003072, the contents of which are incorporated herein in their entirety.

The device preferably comprises a power supply, for example a battery such as a rechargeable battery for supplying energy to heat the aerosol-forming substrate.

In some embodiments. the aerosol-generating device may further comprise a flow meter, for example a flow meter for measuring flow of an air flow path upstream of a cavity for receiving the aerosol-forming substrate. The use of a flow meter may be advantageous in a development application as it may allow effective calibration of a pressure sensor to optimise puff detection for a particular combination of device and substrate. A test system aerosol-generating device for setting up or calibrating specific features such as the pressure sensor and optimising features such as the dimensions of the flow restrictor may be any aerosol-generating device as described herein, with the addition of a flow meter upstream of the restriction. Such a test system may be particularly advantageous if the flow restriction of the test system is a variable flow restriction allowing the dimensions of the restriction to be optimised, for example optimised with respect to a specific aerosol-generating article. A commercial version of the aerosol-generating device may then be produced with the desired settings and without the need for a flow meter.

Advantageously, the aerosol-generating device may be configured, in use, to; determine the start of a usage session, enter a stand-by mode in which an aerosol-forming substrate received in the device is heated, temperature of the aerosol-forming substrate being controlled during stand-by mode with reference to a stand-by target temperature, detect a user puff taken during the usage session, and in response to the detected user puff enter an operational mode in which a greater thermal energy is supplied to the aerosol-forming substrate to increase the temperature of the aerosol-forming substrate, the temperature of the aerosol-forming substrate during operational mode being controlled with reference to an operational target temperature greater than the stand-by target temperature.

The aerosol-generating device may comprise a housing. The housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. The material is preferably light and non-brittle.

The device may comprise one or more power supply or power source, one or more heater, and a controller. The controller may be configured to; enter stand-by mode at the start of the usage sessions, detect the start of a user puff, in response to the detection of the start of the user puff to switch from stand-by mode to operational mode, detect the end of the user puff, and in response to the detection of the end of the user puff to switch from operational mode to stand-by mode.

The power supply may be in the form of a battery. The battery may be rechargeable. The battery may be a Lithium based battery, for example a Lithium-Cobalt, a Lithium-Iron-Phosphate, a Lithium Titanate or a Lithium-Polymer battery. The battery may be a Nickel-metal hydride battery or a Nickel cadmium battery. The power supply may be another form of charge storage device such as a capacitor. The power supply may be rechargeable and be configured for many cycles of charge and discharge. The power supply may have a capacity that allows for the storage of enough energy for one or more user experiences of the aerosol-generating system; for example, the power supply may have sufficient capacity to allow for the continuous generation of aerosol for a period of around six minutes, corresponding to the typical time taken to smoke a conventional cigarette, or for a period that is a multiple of six minutes. In another example, the power supply may have sufficient capacity to allow for a predetermined number of puffs or discrete activations of the aerosol-generating system.

The controller or control circuitry may be, or comprise, comprise any suitable controller or electrical components. The controller may comprise a memory. Information for performing the above-described method may be stored in the memory. The control circuitry may comprise a microprocessor. The microprocessor may be a programmable microprocessor, a microcontroller, or an application specific integrated chip (ASIC) or other electronic circuitry capable of providing control. The control circuitry may be configured to supply power to the heating element continuously following activation of the device, or may be configured to supply power intermittently, such as on a puff-by-puff basis. The power may be supplied to the heating element in the form of pulses of electrical current, for example, by means of pulse width modulation (PWM). The control circuitry may comprise further electronic components. For example, in some embodiments, the control circuitry may comprise any of: sensors, switches, display elements. The controller may be configured to increase the power supplied to the one or more heater during an operational mode relative to a stand-by mode.

According to an aspect of the present invention, there may be provided an aerosol-generating system comprising an aerosol-generating device as described above and an aerosol-generating article comprising an aerosol-forming substrate. The aerosol-generating article is configured to be at least partially received within the aerosol-forming device. The aerosol-forming article may comprise a plurality of components, including the aerosol-forming substrate, assembled within a wrapper.

In some embodiments, the aerosol-generating article may have a resistance to draw (RTD) of between 10 mm H₂O and 50 mm H₂O.

The aerosol-generating system may have a system air flow path defined through the device and the aerosol-generating article when the aerosol-generating article is received in the device, for example in which the system air flow path includes an air flow path defined through the device and an air flow path defined through the aerosol-generating article. The system air flow path may have a resistance to draw (RTD) of between 20 mm H₂O and 100 mm H₂O.

The article may appear substantially similar to a conventional cigarette. The article may be in the form of a rod, or have a rod-like or stick-like shape. The article may be substantially cylindrical, for example right cylindrical, in shape. The article may have a length of between 30 mm and 120 mm, for example between 40 mm and 80 mm, for example about 45 mm. The article may have a diameter of between 3.5 mm and 10 mm, for example between 4 mm and 8.5 mm, for example between 4.5 mm and 7.5 mm.

The substrate may be substantially cylindrical, for example right cylindrical, in shape. References herein have been made to an inner portion and an outer portion of the aerosol-forming substrate. The inner portion may be or comprise aerosol-forming material in an axially central portion, for example axially central cylindrical portion or axially central right cylindrical portion, of the aerosol-forming substrate. The outer portion may be or comprise aerosol-forming material in an axially outer portion of the aerosol-forming substrate. The outer portion may be cylindrical, for example right cylindrical in shape. The outer portion may have an annular, for example circular annular, cross-section. There may be no aerosol-forming substrate between the inner and outer portions. The inner portion and outer portion may be in contact. An entirety of the aerosol-forming material of the aerosol-forming substrate may be found in the inner and outer portions.

Optionally, the article comprises a front plug. Optionally, the article comprises an aerosol-forming substrate. Optionally, the article comprises a first hollow tube, for example a first hollow acetate tube. Optionally, the article comprises a second hollow tube, for example a second hollow acetate tube. Optionally, the second hollow tube comprises one or more ventilation holes. Optionally, the article comprises a mouth plug filter. Optionally, the article comprises wrapper, for example a paper wrapper. Optionally, one or more or all of the front plug, the aerosol-forming substrate, the first hollow tube, the second hollow tube where present, and the mouth plug filter are circumscribed by the wrapper.

Optionally, the front plug is arranged at a most upstream end of the article. Optionally, the aerosol-forming substrate is arranged downstream of the front plug. Optionally, the first hollow tube is arranged downstream of the aerosol-forming substrate. Optionally, the second hollow tube is arranged downstream of the first hollow tube. Optionally, the mouth plug filter is arranged downstream of one or both of the first hollow tube and the second hollow tube. Optionally, the mouth plug filter is arranged at a most downstream end of the article. Optionally, the most downstream end of the article, which may be referred to as a mouth end of the article, may be configured for insertion into a mouth of a user. A user may be able to inhale on, for example directly on, the mouth end of the article.

One or more of the front plug, the aerosol-forming substrate, the first hollow tube, the second hollow tube, and the mouth plug filter may be substantially cylindrical, for example right cylindrical, in shape. One or more of the front plug, the aerosol-forming substrate, the first hollow tube, the second hollow tube, and the mouth plug filter may have a diameter of between 3.5 mm and 10 millimetres. Optionally, the front plug has a length of between 2 and 10 millimetres. Optionally, the aerosol-forming substrate within the article has a length of between 5 and 20 millimetres. Optionally, the first hollow tube has a length of between 2 and 20 millimetres. Optionally, the second hollow tube has a length of between 2 and 20 millimetres. Optionally, the mouth plug filter has a length of between 5 and 20 millimetres.

The article may comprise, or be, a cartridge. The cartridge may hold the aerosol-forming substrate. The cartridge may hold the susceptor. The cartridge may comprise a cartridge housing. One or both of the aerosol-forming substrate and the susceptor may be located within the cartridge housing.

The cartridge may have a length, a width, and a thickness. The thickness may be less than 0.5 or 0.2 times the length, the width, or both. In this case, the cartridge may be termed a flat or planar cartridge. The cartridge may be any suitable shape and size, for example substantially right cylindrical or cuboid. The cartridge may be any of the cartridges described in WO2015177043, the contents of which is incorporated herein.

The susceptor may have a susceptor length, a susceptor width, and a susceptor thickness. The susceptor thickness may be less than 0.5 or 0.2 times the susceptor length, the susceptor width, or both. In this case, the susceptor may be termed a flat or planar susceptor. The aerosol-forming substrate may have a substrate length, a substrate width, and a substrate thickness. The substrate thickness may be less than 0.5 or 0.2 times the substrate length, the substrate width, or both. In this case, the aerosol-forming substrate may be termed a flat or planar aerosol-forming substrate.

The susceptor may form, be attached to, or be located adjacent to, an inner face of the cartridge housing. The susceptor may be in contact with the aerosol-forming substrate. The susceptor may be located between the aerosol-forming substrate and the inner face. A largest or second largest surface of the susceptor may be in contact with, or located adjacent to, a largest or second largest surface of the aerosol-forming substrate. This may be particularly advantageous where one or both of the susceptor and the aerosol-forming substrate are flat or planar. Advantageously, this may maximise heat transfer from the susceptor to the aerosol-forming substrate in use.

According to an aspect of the present invention, there may be provided a method of generating an aerosol using an aerosol-generating device, the aerosol-generating device comprising a cavity for receiving at least a portion of the aerosol-forming substrate, and an air flow path upstream of the cavity through which a user can draw air when using the device, the air flow path connecting the cavity with the external environment, and a pressure sensor located in communication with the air flow path upstream of the cavity, the method comprising steps of: arranging an aerosol-forming substrate within the cavity, actuating the device to operate according to a stand-by mode, detecting pressure changes in the air flow path associated with the start of a user puff, in response to the detected start of the user puff, switching mode of operation from the stand-by mode to an operational mode, detecting pressure changes in the air flow path associated with the end of the user puff, and in response to the detected end of the user puff, switching mode of operation from the operational mode to the stand-by mode.

According to an aspect of the present invention, there may be provided method of operating an aerosol using an aerosol-generating device, the aerosol-generating device comprising; a cavity for receiving at least a portion of the aerosol-forming substrate, and an air flow path upstream of the cavity through which a user can draw air when using the device, the air flow path connecting the cavity with the external environment, the method comprising steps of: arranging an aerosol-forming substrate within the cavity, actuating the device to operate according to a stand-by mode in which the temperature of the aerosol-forming substrate is controlled with reference to a stand-by target temperature, and in response to a user puff, switching mode of operation from the stand-by mode to an operational mode in which the temperature of the aerosol-forming substrate is controlled with reference to an operational target temperature, the operational target temperature being a temperature higher than the stand-by target temperature.

According to an aspect of the present invention, there may be provided method of generating an aerosol using an aerosol-generating device, the aerosol-generating device comprising; a cavity for receiving at least a portion of the aerosol-forming substrate, and an air flow path upstream of the cavity through which a user can draw air when using the device, the air flow path connecting the cavity with the external environment, the device further comprising a first heater arranged in thermal contact with the cavity and a second heater arranged in thermal contact with the air flow path upstream of the cavity, the method comprising steps of: arranging an aerosol-forming substrate within the cavity, actuating the device to operate according to a stand-by mode in which temperature of the aerosol-forming substrate is heated to a stand-by target temperature by the first heater, and drawing air through the air flow path, in which air drawn through the air flow path is heated by the second heater and the temperature of the aerosol-forming substrate is raised from the stand-by target temperature to an operational target temperature higher than the stand-by target temperature.

A method of generating an aerosol may involve any device or system described above.

As used herein, the term “aerosol-generating article”, or simply “article” for short, may refer to an article able to generate, or release, an aerosol, for example when heated.

As used herein, the term “aerosol-forming substrate” may refer to a substrate capable of releasing an aerosol or volatile compounds that can form an aerosol. Such volatile compounds may be released by heating the aerosol-forming substrate. The aerosol-forming substrate may comprise one or more aerosol formers or aerosol-forming materials. An aerosol-forming substrate may be adsorbed, coated, impregnated or otherwise loaded onto a carrier or support. An aerosol-forming substrate may conveniently be part of an aerosol-generating article or smoking article.

Optionally, the aerosol-forming substrate is a solid aerosol-forming substrate. However, the aerosol-forming substrate may comprise both solid and liquid components. Alternatively, the aerosol-forming substrate may be a liquid aerosol-forming substrate.

Optionally, the aerosol-forming substrate comprises nicotine. Optionally, the aerosol-forming substrate comprises tobacco. Alternatively, or in addition, the aerosol-forming substrate may comprise a non-tobacco containing aerosol-forming material.

Optionally, the aerosol-forming substrate may comprise a sheet of aerosol-forming material. For example, the aerosol-forming substrate may comprise a sheet of homogenised tobacco material, for example a crimped and gathered sheet of homogenised tobacco material.

As used herein, the term “aerosol former” may refer to any suitable known compound or mixture of compounds that, in use, facilitates formation of an aerosol and that is substantially resistant to thermal degradation at the operating temperature of the aerosol-generating article. Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as propylene glycol, triethylene glycol, 1,3-butanediol and, most preferred, glycerine. The aerosol-forming substrate may comprise one or more aerosol formers.

As used herein, the “aerosolization temperature” of an aerosol-forming substrate may refer to a minimum temperature at which the aerosol-forming substrate releases an aerosol or volatile compounds that can form an aerosol, or at which the aerosol-forming substrate releases a substantial quantity of an aerosol or volatile compounds that can form an aerosol.

As used herein, the term “usage session” may refer to a period in which a series of puffs are applied by a user to extract aerosol from an aerosol-forming substrate.

As used herein, the term “aerosol-generating device” may refer to a device for use with an aerosol-generating article to enable the generation, or release, of an aerosol.

As used herein, the term “susceptor” may refer to an element comprising a material that is capable of converting the energy of a magnetic field into heat. When a susceptor is located in an alternating magnetic field, the susceptor may be heated. Heating of the susceptor may be the result of at least one of hysteresis losses and eddy currents induced in the susceptor, depending on the electrical and magnetic properties of the susceptor material.

As used herein when referring to an aerosol-generating article or aerosol-generating device, the terms “upstream” and “downstream” may be used to describe the relative positions of components, or portions of components, of the aerosol-generating article or device in relation to the direction in which air flows through the aerosol-generating article or device during use thereof. Aerosol-generating articles may comprise an upstream end through which, in use, air enters the article. Aerosol-generating articles may comprise a downstream end through which, in use, air or aerosol exits the article. Aerosol-generating devices may comprise an upstream end through which, in use, air enters the device. Aerosol-generating articles may comprise a downstream end through which, in use, air or aerosol exits the device. An aerosol-generating system may be configured such that air enters an upstream end of an aerosol-generating device, passes into an upstream end of an aerosol-generating article engaged with eth device, and exits a downstream end of the aerosol-generating article.

As used herein with reference to the invention, the term “longitudinal” is used to describe the direction between the upstream end and the downstream end of the aerosol-generating article or between the upstream end and the downstream end of the aerosol-generating device. During use, air is drawn through the aerosol-generating article in the longitudinal direction.

As used herein with reference to the invention, the term “length” is used to describe the maximum dimension of the aerosol-generating article or the aerosol-generating device or a component of the aerosol-generating article or the aerosol-generating device in the longitudinal direction.

As used herein with reference to the invention, the term “transverse” is used to describe the direction perpendicular to the longitudinal direction. Unless otherwise stated, references to the “cross-section” of the aerosol-generating article or aerosol-generating device or a component of the aerosol-generating article or aerosol-generating device refer to the transverse cross-section.

As used herein with reference to the invention, the term “width” denotes the maximum dimension of the aerosol-generating article or device or of a component of the aerosol-generating article or device in a transverse direction. For example, where the aerosol-generating article has a substantially circular cross-section, the width of the aerosol-generating article corresponds to the diameter of the aerosol-generating article. Where a component of the aerosol-generating article has a substantially circular cross-section, the width of the component of the aerosol-generating article substantially corresponds to the diameter of the component of the aerosol-generating article.

As used herein, the term “heating body” denotes a component which is configured to transfer heat energy to the aerosol-generating substrate.

As used herein, the term “porous portion” denotes a portion of a body which has a plurality of pores, at least some of which are interconnected. Thus, a porous portion of a body may generally define an airflow path through the porous portion, such that a fluid may be able to flow from one end surface of the porous portion to an second end surface of the porous portion opposite the first end surface. In general, a pressure drop across the porous portion will be greater than a pressure drop across a hollow tubular element having the same length of the porous portion and a free cross-sectional area equal to an overall cross-sectional area of the porous portion. Thus, flow across the porous portion will generally be partially restricted compared to flow through a hollow tubular element of comparable dimensions.

The term “porosity” of a body generally denotes the ratio of the volume of the accessible pores and voids to the bulk volume occupied by the body. The term “cross-sectional porosity” refers to the fraction of void space in a cross-sectional area of a porous body, for example a cross-section of a porous portion of a heating body of a heater assembly in accordance with the present invention. The cross-sectional porosity is the area fraction of void space of the transverse cross-sectional area of the porous body. The transverse cross-sectional area of the porous body is the area of the porous body in the plane that is perpendicular to a longitudinal axis of the porous body, which is generally also a longitudinal axis of the heater assembly and a longitudinal axis of an aerosol-generating device comprising the heater assembly.

The porous body will typically be substantially cylindrical, and so a transverse cross-sectional of the porous body will be substantially circular. However, more generally it will be possible to identify a longitudinal axis of the porous body and a transverse cross-section of the porous body will be in a plane substantially perpendicular to said longitudinal axis.

As used herein, the term “electrically insulating” may refer to a material having an electrical conductivity of less than 0.8×10⁴ Siemens per metre, for example a resistivity of at least 1×10⁻⁴, 5×10⁻⁴, or 1×10⁻⁵ Ohm metres, in at least one direction, for example in all directions, at room temperature (20 degrees Celsius) and a relative humidity of 50%.

As used herein, the term “electrically resistive” may refer to a material having an electrical conductivity of at least 0.8×10⁻⁶ Siemens per metre, for example a resistivity of no more than 1×10⁻⁴, 5×10⁻⁵, or 1×10⁻⁵ Ohm metres, in at least one direction, for example in all directions, at room temperature (20 degrees Celsius) and a relative humidity of 50%.

As used herein, the term “thermally conductive” may refer to a material having a thermal conductivity of at least 5, 10, 20, 50, or 100 Watts per metre-Kelvin in at least one direction, for example in all directions, at room temperature (20 degrees Celsius) and a relative humidity of 50%.

Various references have been made to ranges herein, such as temperature ranges. For the avoidance of doubt, unless otherwise specified, any ranges referred to herein may have only an upper limit, only a lower limit, or both an upper limit and a lower limit. A limit for a temperature range, for example any upper or lower limit of any one or more of the temperature ranges for the heating zone, heater, or susceptor as discussed above, may be predetermined. The limit may be stored in the controller or in a memory, for example in a memory of the controller. The limit may be stored as a temperature value or in another form indicative of a temperature value, for example as a value of an electrical resistance of the component to which the temperature range applies. In this case, the electrical resistance of the component may be monitored, rather than the temperature of the component, and compared with a temperature versus electrical resistance dataset to estimate the temperature of the component.

The invention is defined in the claims. However, below there is provided a non-exhaustive list of non-limiting examples. Any one or more of the features of these examples may be combined with any one or more features of another example, embodiment, or aspect described herein.

Below, there is provided a non-exhaustive list of non-limiting examples. Any one or more of the features of these examples may be combined with any one or more features of another example, or embodiment, or aspect described herein.
Exi—An aerosol-generating device configured to generate an aerosol from an aerosol-forming substrate during a usage session, in which the device is configured to heat the aerosol-forming substrate to a stand-by temperature during the usage session and in which the device is configured such that the temperature of the aerosol-forming substrate increases from the stand-by temperature when a user takes a puff.
Exii—An aerosol-generating device according to Exi in which the device is configured to supply a thermal boost to the aerosol-forming substrate during a user puff taken during the user session.
Exiii—An aerosol-generating device according to Exi or Exii, in which the device is configured to heat the aerosol-forming substrate during the usage session according to a stand-by mode or an operational mode, in which during the stand-by mode the temperature of the aerosol-forming substrate is controlled with reference to the stand-by target temperature, and during the operational mode the temperature of the aerosol-forming substrate is controlled with reference to an operational target temperature, the stand-by target temperature being a temperature greater than room temperature and the operational target temperature being a temperature higher than the stand-by target temperature.
Exiv—An aerosol generating device according to Exiii in which operation of the device changes from the stand-by mode to the operational mode when a user starts a puff and from the operational mode to the stand-by mode when the user ends the puff.
Exv—An aerosol-generating device according to any preceding example in which the device is configured to heat the aerosol-forming substrate during the usage session according to a stand-by mode or an operational mode, in which during the stand-by mode the temperature of the aerosol-forming substrate is controlled with reference to a stand-by target temperature, and during the operational mode the temperature of the aerosol-forming substrate is controlled with reference to an operational target temperature, the stand-by target temperature being a temperature greater than room temperature and the operational target temperature being a temperature higher than the stand-by target temperature.
Ex1. An aerosol-generating device configured to generate an aerosol from an aerosol-forming substrate, for example an aerosol-generating device according to any preceding example, in which
the device defines a cavity for receiving at least a portion of the aerosol-forming substrate, and an air flow path upstream of the cavity through which a user can draw air when using the device, the air flow path connecting the cavity with the external environment, in which the device comprises
a first heating portion located at the cavity, and a second heating portion located in thermal contact with the air flow path upstream of the cavity.
Ex2. An aerosol-generating device according to Ex1 in which the first heating portion comprises a heater arranged to at least partially surround the cavity.
Ex3. An aerosol-generating device according to Ex1 or Ex2 in which the first heating portion comprises a heater arranged in contact with walls of the cavity, for example a resistance heater arranged in contact with walls of the cavity.
Ex4. An aerosol-generating device according to Ex3 in which the first heating portion comprises a flexible heater arranged in contact with an inner or outer surface of the cavity, for example a polyimide flexible heater arranged in contact with an inner or outer wall of the cavity.
Ex5. An aerosol-generating device according to any preceding example in which the first heating portion comprises a heater located within the cavity, for example a protruding heater configured to penetrate an aerosol-forming substrate inserted into the cavity.
Ex6. An aerosol-generating device according to any preceding example in which the first heating portion comprises an inductive heating arrangement, for example in which the first heating portion comprises an inductor located external to the cavity configured to heat a susceptor located within the cavity or a susceptor in contact with or forming part of the cavity walls.
Ex7. An aerosol-generating device according to Ex6 in which the cavity walls comprise or are formed from a susceptor material.
Ex8. An aerosol-generating device according to any preceding example in which the first heating portion is configured to directly heat an aerosol-forming substrate received within the cavity.
Ex9. An aerosol-generating device according to any preceding example in which the cavity comprises an air inlet connecting the cavity with the air flow path upstream of the cavity.
Ex10. An aerosol-generating device according to any preceding example in which the second heating portion is located within the air flow path upstream of the cavity.
Ex11. An aerosol-generating device according to any preceding example in which the second heating portion comprises a heater located within the airflow path upstream of the cavity, for example a resistance heater located within the air flow path upstream of the cavity.
Ex12. An aerosol-generating article according to any preceding example in which the second heating portion comprises an inductive heating arrangement, for example in which the second heating portion comprises an inductor configured to heat a susceptor located within the air flow path upstream of the cavity.
Ex13. An aerosol-generating article according to any preceding example in which the second heating portion comprises a porous body, the air flow path being defined through the porous body, preferably in which the air flow path through the second heating portion has a predetermined resistance to draw (RTD).
Ex14. An aerosol-generating article according to any preceding example in which the second heating portion comprises a heat exchanger.
Ex14A An aerosol-generating device according to any of the preceding examples, wherein the first heating portion is formed by a cylindrical or tubular element that is made of resistive material, and the second heating portion is formed as an air permeable body, for example a porous body, inside a portion of the cylindrical or tubular element, for example inside an end of the cylindrical or tubular element opposite an open end for receiving the aerosol-forming substrate, free space such as cavities of the air-permeable body forming the airflow path.
Ex14B An aerosol-generating device according to any of the preceding examples, wherein the first heating portion is formed by a cylindrical or tubular element that is made of resistive material, and the second heating portion is formed as an air-permeable body defining an air-flow path, for example an air-flow path formed by a plurality of tubular or meandering structures, inside a portion of the cylindrical or tubular element, for example inside a portion of the cylindrical or tubular element opposite an open end for receiving the aerosol-forming substrate, the plurality of tubular or meandering structures within the air-permeable body forming the airflow path.
Ex14C An aerosol-generating device according to any of the preceding examples, wherein the first and second heating portion are formed as a unitary structure of the same electrically resistive heater material.
Ex15. An aerosol-generating article according to any preceding example in which the second heating portion comprises a heating body configured for resistance heating, which may be termed Joule heating, the heating body including a polymer composite comprising a polymeric matrix and a plurality of conductive particles dispersed within the polymer matrix.
Ex16. An aerosol-generating article according to Ex15 in which the polymer composite comprises a polymeric matrix and a plurality of non-metallic conductive particles dispersed within the polymer matrix, for example in which the plurality of non-metallic conductive particles comprises one or more of a plurality of carbon particles, such as graphite particles, and a plurality of boron nitride particles, for example hexagonal boron nitride particles.
Ex17. An aerosol-generating device according to Ex15 or Ex16 in which the polymeric matrix comprises at least one of polyether ether ketone (PEEK) and a liquid crystal polymer (LCP).
Ex18. An aerosol-generating device according to any of Ex15 to Ex17, in which the polymeric matrix accounts for between 22 percent and 33 percent by weight of the heat-conducting element.
Ex19. An aerosol-generating device according to any of Ex15 to Ex18, in which the plurality of non-metallic conductive particles comprises at least one of expanded graphite particles and graphite nanoplatelets.
Ex20. An aerosol-generating device according to any of Ex15 to Ex19, in which the non-metallic conductive particles account for between 62 percent and 69 percent by weight of the polymer composite.
Ex21. An aerosol-generating device according to any of Ex15 to Ex20, in which the polymer composite further comprises at least one additive dispersed within the polymeric matrix, for example in which the at least one additive is or comprises carbon black.
Ex22. An aerosol-generating device according to any of Ex15 to Ex21, wherein the heating body is formed by sintering particles of the polymer composite.
Ex23. An aerosol-generating device according to any of Ex15 to Ex22, wherein the heating body has a total pore volume of less than 5 cubic centimetres.
Ex24. An aerosol-generating device according to any of Ex15 to Ex23, wherein a total pore volume of the heating body is at least 0.5 cubic centimetres. Ex 25. An aerosol-generating device according to any of Ex15 to Ex24, wherein an RTD of the heating body is greater than 10 millimetres H2O.
Ex26. An aerosol-generating device according to any of Ex15 to Ex25, wherein an RTD of the heating body is less than 40 millimetres H2O.
Ex27. An aerosol-generating device according to any of Ex15 to Ex26, wherein the second heating portion comprises an inductor coil extending around at least a portion of the heating body, for example wherein a power supply and a controller are connected to the inductor coil and configured to provide a varying electric current to the inductor coil such that, in use, the inductor coil generates a varying magnetic field.
Ex28. An aerosol-generating device according to Ex27, wherein the inductor coil is positioned in direct contact with an outer surface of the heating body.
Ex29. An aerosol-generating device according to any preceding example in which the device is configured to generate an aerosol from an aerosol-forming substrate during a usage session having a usage session start and a usage session end.
Ex30. An aerosol-generating device according to Ex29 in which the device is configured to distinguish between a puff period and a non-puff period, a puff period being defined as any period during the usage session in which a user is actively taking a puff, and a non-puff period being defined as any period during the usage session when a user is not actively taking a puff.
Ex31. An aerosol-generating device according to any preceding example in which the device is configured to heat the aerosol-forming substrate during a usage session with reference to two different target temperatures, a stand-by target temperature and an operational target temperature, the stand-by target temperature being a temperature greater than room temperature and the operational target temperature being higher than the stand-by target temperature.
Ex32. An aerosol-generating device according to any preceding example configured to generate an aerosol from an aerosol-forming substrate during a usage session, in which the device is configured to heat the aerosol-forming substrate during the usage session with reference to two different target temperatures, a stand-by target temperature and an operational target temperature, the stand-by target temperature being a temperature greater than room temperature and the operational target temperature being higher than the stand-by target temperature, in which the device is configured to heat the aerosol-forming substrate to the stand-by temperature during the usage session, and in which the device is further configured to heat the aerosol-forming substrate from the stand-by target temperature to the operational target temperature during a user puff undertaken during the usage session, the aerosol-forming substrate being allowed to cool from the operational target temperature after the end of the user puff.
Ex33. An aerosol-generating device according to Ex32 in which the first heating portion is configured to supply energy to heat the aerosol-forming substrate to the stand-by temperature and the second heating portion is configured to heat the aerosol-forming substrate to the operational temperature during user puffs.
Ex34. An aerosol-generating device according to any preceding example configured to generate an aerosol from an aerosol-forming substrate during a usage session, in which both the first heating portion and the second heating portion are actuated at a start of the usage session, the first heating portion being configured to directly heat an aerosol-forming substrate received in the cavity and the second heating portion configured to heat air drawn into the air flow path by a user puff.
Ex35. An aerosol-generating device according to any preceding example configured to detect a user puff.
Ex35A. An aerosol-generating device according to Ex35 in which power is only supplied to the second heating portion during a user puff.
Ex35B. An aerosol-generating device according to Ex35 in which power supplied to the second heating portion is increased during a user puff.
Ex36. An aerosol-generating device according to any preceding example further comprising an air flow detector for detecting a user puff, for example a pressure sensor located in the airflow path, for example in the air flow path upstream of the cavity.
Ex37. An aerosol-generating device configured to generate an aerosol from an aerosol-forming substrate during a usage session, for example an aerosol-generating device according to any preceding example, in which the device is configured to heat the aerosol-forming substrate during the usage session with reference to two different target temperatures, a stand-by target temperature and an operational target temperature, the stand-by target temperature being a temperature greater than room temperature and the operational target temperature being higher than the stand-by target temperature, in which the device is configured to heat the aerosol-forming substrate to the stand-by temperature during the usage session, and in which the device is further configured to heat the aerosol-forming substrate from the stand-by target temperature to the operational target temperature during a user puff undertaken during the usage session, the aerosol-forming substrate being allowed to cool from the operational target temperature after the end of the user puff.
Ex38. An aerosol-generating device according to any preceding example, in which the stand-by target temperature is a temperature that is too low to evolve a substantial aerosol from the aerosol-forming substrate.
Ex39. An aerosol-generating device according to any preceding example, in which the stand-by target temperature is lower than an effective boiling point of the aerosol-former or aerosol-former mixture of the aerosol-forming substrate, for example lower than the boiling point of propylene glycol, or lower than the boiling point of glycerol, or lower than the boiling point of the specific mixture of propylene glycol and glycerol used as an aerosol-former in the aerosol-forming substrate.
Ex40. An aerosol-generating device according to any preceding example in which the stand-by target temperature is lower than 250° C., for example lower than 230° C., for example lower than 210° C., preferably lower than 200° C., for example lower than 180° C., or lower than 160° C.
Ex41. An aerosol-generating device according to any preceding example in which the stand-by target temperature is a temperature of between 50° C. and 250° C., for example between 80° C. and 200° C., for example between 100° C. and 180° C.
Ex42. An aerosol-generating device according to any preceding example, in which the operational target temperature is a temperature that is high enough to evolve an aerosol from the aerosol-forming substrate.
Ex43. An aerosol-generating device according to any preceding example, in which the operational target temperature is higher than an effective boiling point of the aerosol-former or aerosol-former mixture of the aerosol-forming substrate, for example higher than the boiling point of propylene glycol, or higher than the boiling point of glycerol, or higher than the boiling point of the specific mixture of propylene glycol and glycerol used as an aerosol-former in the aerosol-forming substrate.
Ex44. An aerosol-generating device according to any preceding example in which the operational target temperature is greater than 160° C., for example greater than 180° C., or greater than 200° C., or greater than 250° C., for example greater than 280° C., or greater than 300° C., or greater than 320° C., or greater than 340° C.
Ex45. An aerosol-generating device according to any preceding example in which the operational target temperature is a temperature of between 160° C. and 400° C., for example between 180° C. and 340° C., for example between 220° C. and 300° C.
Ex46. An aerosol-generating device according to any preceding example in which the stand-by target temperature is constant throughout the duration of the usage session.
Ex47. An aerosol-generating device according to any preceding example apart from Ex46 in which the stand-by target temperature varies over the duration of the usage session.
Ex48. An aerosol-generating device according to any preceding example in which the operational target temperature is constant throughout the duration of the usage session.
Ex49. An aerosol-generating device according to any preceding example apart from Ex48 in which the operational target temperature varies over the duration of the usage session, for example in which the operational target temperature varies from puff to puff.
Ex50. An aerosol-generating device according to any preceding example in which the usage session has a usage session start and a usage session end, in which the aerosol-forming substrate is heated to the stand-by target temperature at the usage session start and maintained at or above the stand-by target temperature over a duration of the usage session until the usage session end.
Ex51. An aerosol-generating device according to any preceding example in which the usage session is defined between a usage session start and a usage session end, in which a puff period is defined as any period during the usage session in which a user is actively taking a puff, and a non-puff period is defined as any period during the usage session when a user is not actively taking a puff, and in which the temperature of the aerosol-forming substrate is controlled with reference to the stand-by target temperature during a non-puff period and with respect to the operational target temperature during a puff period.
Ex52. An aerosol-generating device according to example Ex51 in which each of one or more puffs taken during the usage session has a puff start and a puff end, and in which the period between the puff start and the puff end is a puff period.
Ex53. An aerosol-generating device according to any preceding example in which the usage session has a usage session duration, for example a predetermined duration set with reference to time, or with reference to a usage parameter, or with reference to both time and a usage parameter.
Ex54. An aerosol-generating device according to example Ex53 in which a usage parameter is a parameter selected from the list consisting of, number of user puffs taken during the usage session, volume of aerosol generated during the usage session, and power supplied to a heater during the usage session.
Ex55. An aerosol-generating device according to any preceding example in which the device is configured to detect one or more user puffs taken during the usage session.
Ex56. An aerosol-generating device according to any preceding example in which in which the device is configured to distinguish between a puff period and a non-puff period, a puff period being defined as any period during the usage session in which a user is actively taking a puff, and a non-puff period being defined as any period during the usage session when a user is not actively taking a puff.
Ex57. An aerosol-generating device according to any preceding example in which the device is configured to detect the start of a user puff taken during the usage session, for example each user puff taken during the usage session.
Ex58. An aerosol-generating device according to any preceding example in which the device is configured to detect the end of a user puff taken during the usage session, for example each user puff taken during the usage session.
Ex59. An aerosol-generating device according to any preceding example in which the device is configured to determine the duration of a user puff taken during the usage session, for example each user puff taken during the usage session.
Ex60. An aerosol-generating device according to any preceding example in which the device is configured to characterise a user puff taken during the usage session, for example each puff taken during the usage session.
Ex61. An aerosol-generating device according to Ex60 in which the device is configured to characterise a detected user puff taken during the usage session, for example each detected user puff taken during the usage session.
Ex62. An aerosol-generating device according to Ex60 or Ex61 in which the device is configured to determine the volume of aerosol generated during the user puff taken during the usage session, for example each user puff taken during the usage session.
Ex63. An aerosol-generating device according to any preceding example in which the device comprises a pressure sensor for use in the detection of one or more user puffs taken during the usage session.
Ex64. An aerosol-generating device according to Ex63 in which the pressure sensor detects changes in pressure of an air flow path as a result of a user taking a puff, for example in which a puff involves a user drawing air through a portion of the device along an air flow path and the pressure sensor detects changes in pressure of the air flow path as a result of a user taking a puff.
Ex65. An aerosol-generating device according to any preceding example in which the device defines a cavity for receiving at least a portion of the aerosol-forming substrate, and an air flow path upstream of the cavity through which a user can draw air when using the device, the air flow path connecting the cavity with the external environment.
Ex66. An aerosol-generating device according to Ex65 in which the air flow path upstream of the cavity acts as a flow restrictor or comprises a flow restrictor.
Ex67. An aerosol-generating device according to Ex66 in which the flow restrictor comprises a mechanical element located within the air flow path, for example an orifice plate located within the air-flow path.
Ex68. An aerosol-generating device according to Ex66 in which the flow restrictor is a variable flow restrictor, for example in which the flow restrictor is an adjustable valve.
Ex69. An aerosol-generating device according to any of Ex66 to Ex68 in which a portion of the air flow path upstream of the cavity has a cross-sectional area of less than 3 mm², for example less than 2 mm², or less than 1.5 mm², or less than 1 mm^{2 .}
Ex70. An aerosol-generating device according to any of Ex66 to Ex69 in which the air flow path upstream of the cavity has a resistance to draw (RTD) of greater than 10 mm H₂O, for example between 10 mm H₂O and 50 mm H₂O.
Ex70A. An aerosol-generating device according to any preceding example in which a pressure sensor is located upstream of the cavity but downstream of a flow restrictor.
Ex70B. An aerosol-generating device according to Ex70A in which the air flow path upstream of the cavity comprises a flow restrictor and an expansion zone downstream of the flow restrictor, in which the pressure sensor is located at the expansion zone.
Ex70C. An aerosol-generating device according to Ex70B in which the air flow path upstream of the expansion zone has a resistance to draw (RTD) of greater than 10 mm H₂O, for example greater than 20 H₂O, or greater than 30 H₂O, preferably between 10 mm H₂O and 50 mm H₂O, for example in which a portion of the air flow path comprising the flow restrictor provides a resistance to draw (RTD) of between 10 mm H₂O and 50 mm H₂O.
Ex71. An aerosol-generating device according to any preceding example in which the device is configured to monitor a parameter indicative of aerosol generation during operation of the aerosol-generating device and to use the monitored parameter in the detection of one or more user puffs taken during the usage session.
Ex72. An aerosol-generating device according to Ex71 in which the monitored parameter is analysed to identify a user puff, the user puff defined by a puff start and a puff end.
Ex73. An aerosol-generating device according to Ex71 or Ex72 in which the monitored parameter is representative of power supplied by the power supply.
Ex74. An aerosol-generating device according to any of Ex72 to Ex73 in which analysis of the monitored parameter comprises steps of calculating a first characteristic of the monitored parameter and analysing the first characteristic to determine a puff start and a puff stop.
Ex75. An aerosol-generating device according to Ex74 in which analysis of the monitored parameter comprises steps of calculating a second characteristic of the monitored parameter and analysing both the first characteristic and the second characteristic to determine the puff start and the puff stop.
Ex76. An aerosol-generating device according to Ex75 in which a puff start is determined when the first characteristic and the second characteristic satisfy one or more predetermined conditions.
Ex77. An aerosol-generating device according to Ex76 in which a puff end is determined when the first characteristic and the second characteristic satisfy one or more predetermined conditions.
Ex78. An aerosol-generating device according to any of Ex74 to Ex77 in which the first characteristic is a first moving average value of the monitored parameter computed on a first time window having a first time window duration.
Ex79. An aerosol-generating device according to any of Ex74 to Ex78 in which the second characteristic is a second moving average value of the monitored parameter computed on a second time window having a second time window duration, the second time window duration being different to the first time window duration.
Ex80. An aerosol-generating device according to Ex79 in which a puff start is determined when the first moving average value and the second moving average value meet a predetermined relationship with respect to each other.
Ex81. An aerosol-generating device according to any preceding example in which the device defines an air flow path through which a user can draw air when using the device.
Ex82. An aerosol-generating device according to any preceding example in which the device defines a cavity having an opening for receiving at least a portion of the aerosol-forming substrate.
Ex83. An aerosol-generating device according to Ex82 in which the device defines an air flow path upstream of the cavity through which a user can draw air when using the device, the air flow path connecting the cavity with the external environment.
Ex84. An aerosol-generating device according to any preceding example in which the device comprises a power supply.
Ex85. An aerosol-generating device according to any preceding example in which the device comprises a heater for heating the aerosol-forming substrate.
Ex86. An aerosol-generating device according to any preceding example in which the device comprises a heater for heating an external portion of the aerosol-forming substrate, for example a heater that surrounds or partially surrounds a portion of an aerosol-forming substrate received in the device.
Ex87. An aerosol-generating device according to any preceding example in which the device comprises a heater for heating an internal portion of the aerosol-forming substrate, for example a heater that is insertable into a portion of an aerosol-forming substrate received in the device.
Ex88. An aerosol-generating device according to any preceding example in which the device comprises a heater for heating air in an air flow path upstream of an aerosol-forming substrate, for example a heater that heats air that is drawn into the device such that the heated air acts to heat an aerosol-forming substrate received in the device.
Ex89. An aerosol-generating device according to any preceding example in which the device comprises a controller for controlling generation of aerosol, for example a controller in communication with a power supply and a heater.
Ex90. An aerosol-generating device according to any preceding example in which the device comprises a resistance heater arranged to heat an aerosol-forming substrate received in a cavity of the device.
Ex91. An aerosol-generating device according to any preceding example in which the device comprises an induction heater arranged to heat an aerosol-forming substrate received in a cavity of the device, for example in which the device comprises an inductor arranged to heat a susceptor in thermal communication with an aerosol-forming substrate received in a cavity of the device.
Ex92. An aerosol-generating device according to any preceding example in which the device is configured to determine a temperature of the aerosol-forming substrate during use.

Ex93. An aerosol-generating device according to any preceding example in which the device comprises a controller configured to determine a temperature of the aerosol-forming substrate during use, the temperature being determined by monitoring behaviours of the heater during use, for example by monitoring apparent resistance or apparent conductance of the heater.
Ex94. An aerosol-generating device according to any preceding example in which the device comprises a sensor configured to determine a temperature of the aerosol-forming substrate during use, for example a positive temperature coefficient (PTC) sensor, a thermocouple, a thermal switch, or any other temperature regulating element.
Ex95. An aerosol-generating device according to any preceding example in which the device further comprises a flow meter, for example a flow meter for measuring flow of an air flow path upstream of a cavity for receiving the aerosol-forming substrate.
Ex96. An aerosol-generating device according to any preceding example in which the device is configured, in use, to; determine the start of a usage session, enter a stand-by mode in which an aerosol-forming substrate received in the device is heated, temperature of the aerosol-forming substrate being controlled during stand-by mode with reference to a stand-by target temperature,
detect a user puff taken during the usage session, and in response to the detected user puff enter an operational mode in which a greater thermal energy is supplied to the aerosol-forming substrate to increase the temperature of the aerosol-forming substrate, the temperature of the aerosol-forming substrate during operational mode being controlled with reference to an operational target temperature greater than the stand-by target temperature.
Ex97. An aerosol-generating device according to Ex96 in which the device comprises one or more power source, one or more heater, and a controller, in which the controller is configured to;
enter stand-by mode at the start of the usage sessions, detect the start of a user puff,
in response to the detection of the start of the user puff to switch from stand-by mode to operational mode, detect the end of the user puff, and in response to the detection of the end of the user puff to switch from operational mode to stand-by mode.
Ex98. An aerosol-generating device according to Ex96 or Ex97 in which the controller increases the power supplied to the one or more heater during the operational mode relative to the stand-by mode.
Ex99. An aerosol-generating device according to any of Ex96 to Ex98 in which the device comprises a first heater and a second heater, in which the first heater is arranged to heat the aerosol-forming substrate during stand-by mode and the second heater is not arranged to heat the aerosol-forming substrate during stand-by mode.
Ex100. An aerosol-generating device according to any of Ex96 to Ex99 in which the device comprises a first heater and a second heater, in which both the first heater and the second heater are arranged to heat the aerosol-forming substrate during operational mode.
Ex101. An aerosol-generating device according to any of Ex99 to Ex100 in which the first heater is arranged to operate during the usage session and the second heater is arranged to be actuated during user puffs, for example in which the second heater is only switched on during user puffs, or in which power supplied to the second heater is increased during user puffs.
Ex102. An aerosol-generating system comprising an aerosol-generating device according to any preceding example and an aerosol-generating article comprising an aerosol-forming substrate, the aerosol-generating article configured to be at least partially received within the aerosol-forming device.
Ex103. An aerosol-generating system according to Ex102 in which the aerosol-forming article comprises a plurality of components including the aerosol-forming substrate assembled within a wrapper.
Ex104. An aerosol-generating system according to Ex102 or Ex103 in which the aerosol-generating article has a resistance to draw (RTD) of between 10 mmH2O and 50 mmH2O.
Ex105. An aerosol-generating system according to Ex102 or Ex103 in which a system air flow path is defined through the device and the aerosol-generating article when the aerosol-generating article is received in the device, for example in which the system air flow path includes an air flow path defined through the device and an air flow path defined through the aerosol-generating article, for example in which the system air flow path has a resistance to draw (RTD) of between 20 mmH2O and 100 mmH2O.
Ex106. A method of generating an aerosol using an aerosol-generating device, the aerosol-generating device comprising; a cavity for receiving at least a portion of the aerosol-forming substrate, and an air flow path upstream of the cavity through which a user can draw air when using the device, the air flow path connecting the cavity with the external environment, and
a pressure sensor located in communication with the air flow path upstream of the cavity, the method comprising steps of: arranging an aerosol-forming substrate within the cavity,
actuating the device to operate according to a stand-by mode, detecting pressure changes in the air flow path associated with the start of a user puff, in response to the detected start of the user puff, switching mode of operation from the stand-by mode to an operational mode, detecting pressure changes in the air flow path associated with the end of the user puff, and in response to the detected end of the user puff, switching mode of operation from the operational mode to the stand-by mode.
Ex107. A method of operating an aerosol using an aerosol-generating device, the aerosol-generating device comprising; a cavity for receiving at least a portion of the aerosol-forming substrate, and an air flow path upstream of the cavity through which a user can draw air when using the device, the air flow path connecting the cavity with the external environment, the method comprising steps of: arranging an aerosol-forming substrate within the cavity, actuating the device to operate according to a stand-by mode in which the temperature of the aerosol-forming substrate is controlled with reference to a stand-by target temperature, and in response to a user puff, switching mode of operation from the stand-by mode to an operational mode in which the temperature of the aerosol-forming substrate is controlled with reference to an operational target temperature, the operational target temperature being a temperature higher than the stand-by target temperature.
Ex108. A method of generating an aerosol using an aerosol-generating device, the aerosol-generating device comprising; a cavity for receiving at least a portion of the aerosol-forming substrate, and an air flow path upstream of the cavity through which a user can draw air when using the device, the air flow path connecting the cavity with the external environment, the device further comprising a first heater arranged in thermal contact with the cavity and a second heater arranged in thermal contact with the air flow path upstream of the cavity, the method comprising steps of:
arranging an aerosol-forming substrate within the cavity, actuating the device to operate according to a stand-by mode in which temperature of the aerosol-forming substrate is heated to a stand-by target temperature by the first heater, and drawing air through the air flow path, in which air drawn through the air flow path is heated by the second heater and the temperature of the aerosol-forming substrate is raised from the stand-by target temperature to an operational target temperature higher than the stand-by target temperature.
Ex109. A method of generating an aerosol-according to Ex106, Ex107, or Ex108 using a device as defined in any of examples Exi to Ex101, or a system as defined in any of Ex102 to E105.

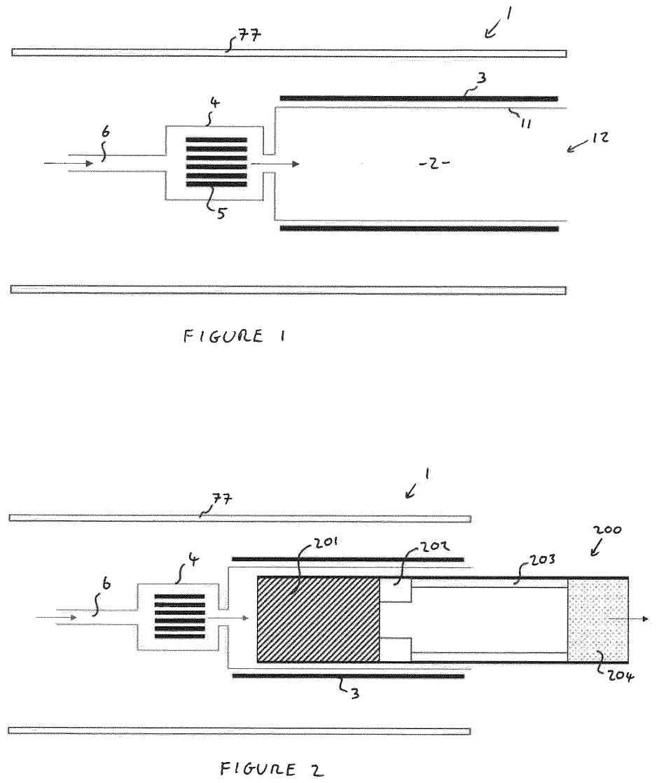

The invention is further described, by way of example only, with reference to the accompanying drawings in which:
FIG. 1 shows a schematic cross-sectional view of a portion of an aerosol-generating device;
FIG. 2 shows the aerosol-generating device of FIG. 1 engaged with an aerosol-generating article;

FIG. 3 is a time/temperature plot illustrating a heating profile applied to an aerosol-forming substrate using the device of FIG. 1;

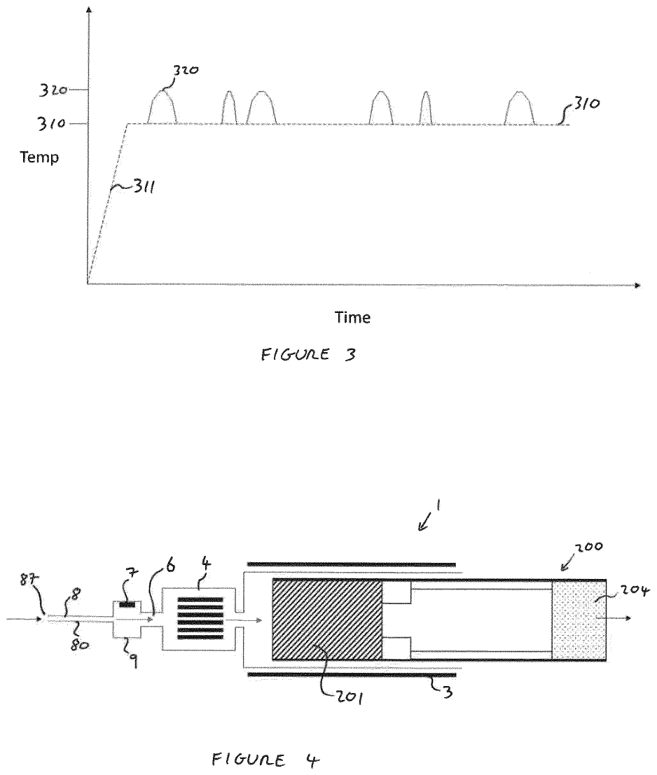

FIG. 4 shows a schematic cross-sectional view of a portion of an aerosol-generating device according to an embodiment of the invention illustrating a pressure sensor located in an air flow path;

FIG. 5 shows a schematic cross-sectional view of a portion of a further aerosol-generating device according to an embodiment of the invention illustrating a pressure sensor located in an air flow path;

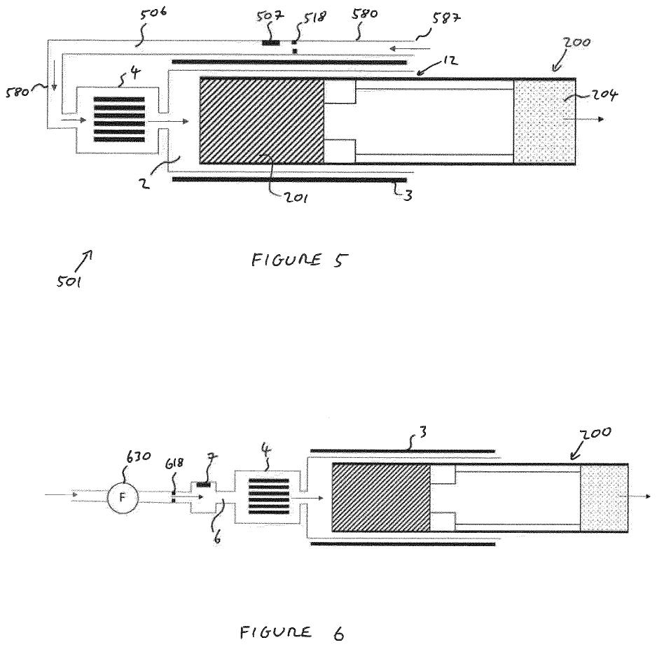

FIG. 6 shows a schematic cross-sectional view of a portion of an aerosol-generating device according to an embodiment of the invention configured as a test device with an additional flow meter;

FIG. 7 shows a schematic illustration of a heater assembly for use in an aerosol-generating device according to embodiments of the invention;

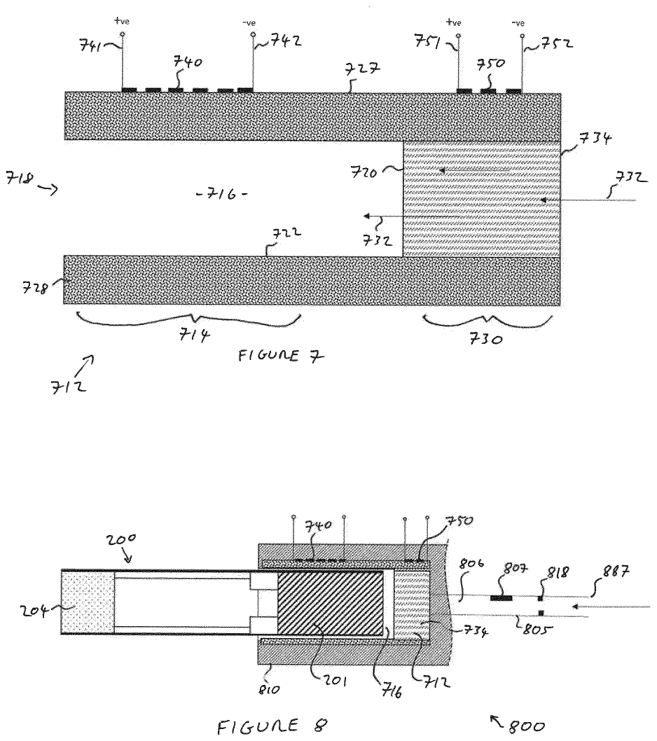

FIG. 8 shows a schematic cross-sectional view of a portion of a further aerosol-generating device according to an embodiment of the invention comprising the heater assembly of FIG. 7;

FIG. 9 shows a schematic illustration of a further heater assembly for use in an aerosol-generating device according to embodiments of the invention.

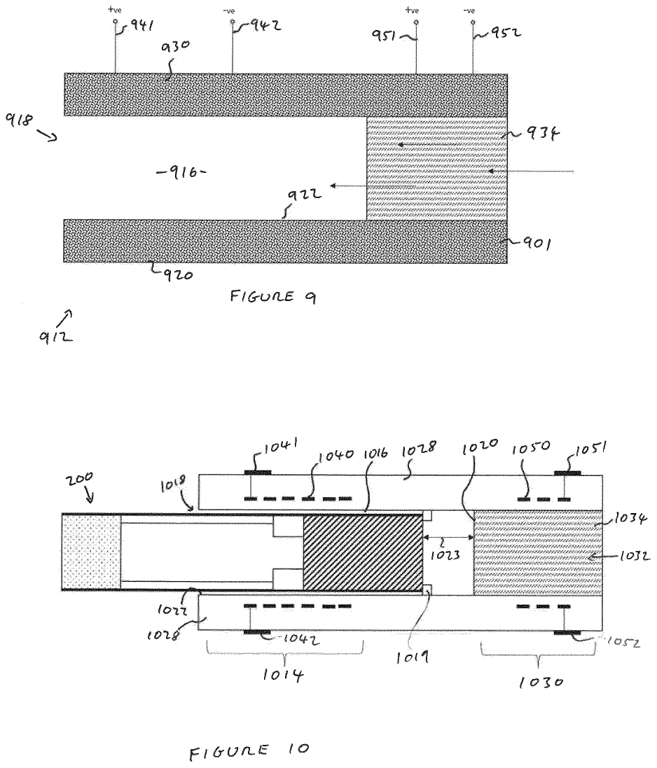

FIG. 10 shows a schematic illustration of a further aerosol-generating device according to embodiments of the invention when engaged with an aerosol-generating article;

FIG. 11 shows a schematic cross-sectional illustration of a further heater assembly for use in an aerosol-generating device according to embodiments of the invention;

FIG. 12 shows a schematic end projection of the heater assembly of FIG. 11;

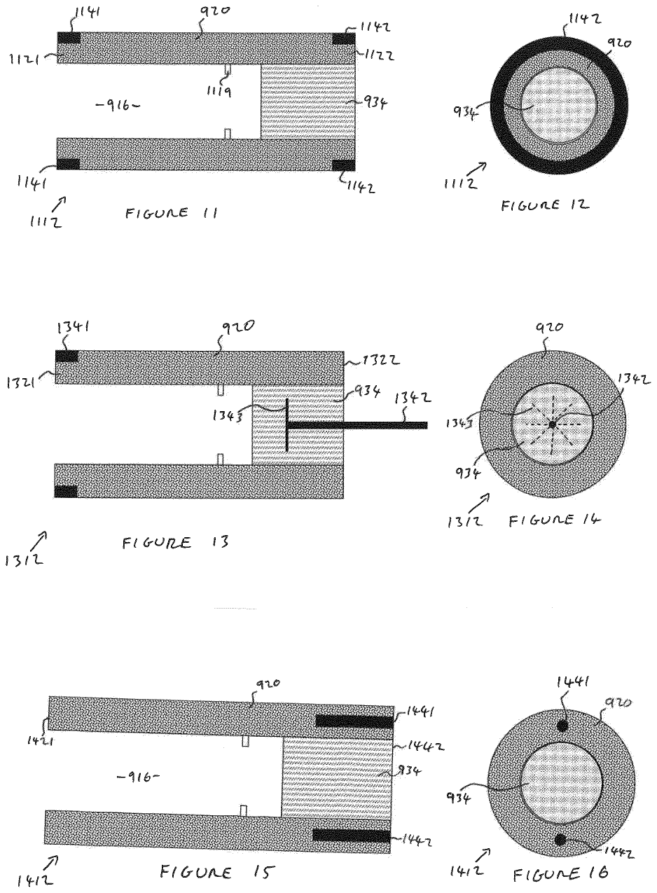

FIG. 13 shows a schematic cross-sectional illustration of a further heater assembly for use in an aerosol-generating device according to embodiments of the invention;

FIG. 14 shows a schematic end projection of the heater assembly of FIG. 13;

FIG. 15 shows a schematic cross-sectional illustration of a further heater assembly for use in an aerosol-generating device according to embodiments of the invention; and

FIG. 16 shows a schematic end projection of the heater assembly of FIG. 15.

FIG. 1 is a schematic cross-sectional view illustrating of a portion of an aerosol-generating device 1. The device 1 comprises an open end 12 through which a portion of an aerosol-generating article may be inserted into a heating chamber 2. The heating chamber 2, which may be alternatively termed a heating cavity, is dimensioned to receive a portion of a rod-shaped aerosol-generating article. The chamber 2 is defined by longitudinally extending walls 11, and a first heater 3 surrounds the walls 11 to provide thermal energy to heat the chamber 2 and any contents of the chamber. In an exemplary embodiment the first heater is a resistance heater. The device defines an air flow path 6 leading from an inlet of the device to the chamber 2. A second heater 4 is located in the air flow path 6 upstream of the chamber 2. The second heater 4 is arranged to heat air drawn through the air flow path 6 and into the chamber 2. The second heater 4 may provide a large area of heating surface to efficiently heat air passing through. For example, the second heater 4 may comprise a plurality of heater plates 5 through which air is drawn. The second heater may comprise a highly porous heater body which acts as a heat exchanger.

The chamber 2, the first heater 3, the second heater 4 and the air flow path 6 are located within a housing 77. The housing also contains a power source such as a battery, and a controller arranged to control supply of power from the power source to the first and second heaters. The battery and the controller are not shown in FIG. 1, but the arrangement of such components within the housing of an aerosol-generating device is well known.

FIG. 2 illustrates the same portion of an aerosol-generating device as depicted in FIG. 1 with an aerosol-generating article 200 inserted into the chamber. The exemplary aerosol-generating article 200 illustrated in FIG. 2 comprises an aerosol-forming substrate 201 formed from a gathered sheet of homogenised tobacco, a hollow acetate tube 202 located immediately downstream of the aerosol-forming substrate, a free-flow filter (a wide bore structural tube) 203 located downstream of the hollow acetate tube, and a mouthpiece filter 204 located downstream of the free-flow filter. These components are arranged within a wrapper 205, for example within a cigarette paper wrapper. This typical aerosol-generating article 200 resembles a conventional cigarette. In use, the front end, or distal portion, of the aerosol-generating article 200 is inserted into the chamber 2 of the aerosol-generating device 1, such that the aerosol-forming substrate 201 is located within the chamber 2. The mouth end, or proximal end, of the aerosol-generating article projects from the chamber 2, thereby allowing a user to draw on the mouth end of the article 200. When a user draws on the mouth end of an article 200 that is located in the chamber 3, air is drawn into the inlet of the device, through the air flow path 6, through the second heater 4, into the chamber 2, through the aerosol-forming substrate 201 of the article 200, and into the users mouth. When the aerosol-forming substrate is heated above its aerosolization temperature, volatile components of the aerosol-forming substrate may be volatilised. These volatilised components may be entrained in air flow when a user draws on the article and condense to form an inhalable aerosol that is consumed by the user.

In an exemplary method of use, an aerosol-generating article may be consumed during a usage session using a dual-heating-mode regime. A chart exemplifying such a heating profile is provided as FIG. 3. When an article 200 is inserted into the chamber 2 of the device and a usage session is initiated, the controller actuates the first heater to heat the aerosol forming substrate and control the temperature of the aerosol-forming substrate at a stand-by target temperature 310. The stand-by target temperature 310 is a temperature below the aerosolization temperature of the aerosol-forming substrate. That is, the stand-by temperature is below a temperature at which volatile components of the aerosol-forming substrate volatilise in significant quantities, and therefore below a temperature at which an aerosol can form. Preferably the stand-by target temperature is only slightly below the aerosolization temperature of the substrate. For example, the stand-by target temperature may be 170° C., in which case the temperature of the substrate is increased from ambient temperature to the stand-by target temperature during a heating phase 311. Once the substrate has reached the stand-by target temperature, power supply to the first heater is controlled to maintain the temperature of the substrate at the stand-by target temperature. Thus, the stand-by target temperature may be termed a maintenance temperature, and the first heater may be termed a maintenance heater.

The temperature of the aerosol-forming substrate may be directly measured with a temperature sensor. Alternatively, the temperature of the substrate may be determined by monitoring electrical parameters of the heater, such as the resistance of the heater or power supplied to the heater.

The second heater 4 may be activated at the start of the usage session, or may only be activated when a user takes a puff. When a user draws on the article 200, air is drawn through the air flow path 6 and the second heater 4. The air passing through the second heater 4 is heated and then this heated air passes into the chamber 2 and through the aerosol-forming substrate 201. The aerosol-forming substrate is already maintained at the stand-by target temperature. Heat from the incoming air flow provides a boost to the temperature of the aerosol-forming substrate and the substrate 201 is heated almost instantaneously to a temperature higher than the stand-by temperature. Thus, the second heater 4 may be termed a boost heater. The temperature may be controlled with respect to a second temperature that is higher than the stand-by target temperature 310. This second temperature may be termed the operational target temperature 320. The operational target temperature is a temperature that is above the aerosolization temperature for the aerosol-forming substrate. For example, the operational target temperature may be a temperature of 250° C., at which temperature aerosol formers and nicotine are volatilised and an aerosol comprising those components may be formed.

Thus, the temperature of the aerosol-forming substrate is maintained at a temperature just below the aerosolization temperature using a maintenance heater, and then boosted to a temperature higher than the aerosolization temperature when a user takes a puff. This provides an advantage that the aerosol forming substrate is only depleted of its aerosol forming components when a user takes a puff, which may allow less aerosol-forming material to be used in an article. If the boost heater is only activated during a user puff, then the dual-heating-mode configuration may provide energy savings over the duration of a usage session.

In the embodiment described with reference to FIGS. 1 to 3 the maintenance heater is a resistance heater surrounding the chamber 2 and the boost heater is a high surface area heater arranged in the air flow path upstream of the cavity. It is possible to provide a dual-heating-mode aerosol generating device having other heater configurations, however. For example, the boost heater may be a heater arranged to directly heat the chamber. For example, the boost heater could be an induction heater arranged to heat a susceptor in thermal contact with the aerosol-forming substrate. As a further example, the maintenance heater may surround the chamber while the boost heater may be an internal heater designed to penetrate the aerosol-forming substrate. Either or both of the heaters may be an induction heater. In another variant, the maintenance heater can be a capacitive or dielectric type heater that heats the substrate material with microwaves. Either or both of the heaters may be a capacitive or dielectric type heater.

FIG. 4 illustrates a portion of an aerosol-generating device 1 as described above, further comprising a pressure sensor 7 located upstream of the second heater 4 in the air flow path 6. An exemplary and non-limiting embodiment of the pressure sensor could be STMicroelectronics LPS22HB, which is a compact piezoresistive absolute pressure sensor and is coupled to a controller of the device 1. A channel 80, extending from an air inlet 87 and defining the air flow path 6, has a greater cross-sectional area at a sensing portion 9 locating the pressure sensor 7 than at a restriction portion 8 upstream of the sensing portion 9. The restriction portion 8 of the channel 80 defining the air flow path 6 acts as a restriction in the air flow path resulting in a pressure drop in the sensing portion when a user draws air through the air flow channel 80. Thus, the restriction portion 8 may be termed a flow restrictor. This pressure drop may be detected by the pressure sensor, signals from which are sent to the controller thereby allowing detection of the start and end of a user puff. The pressure drop resulting from a user puff is increased in the region of the restriction due to increased air velocity through the restriction. This increased pressure drop is easier to differentiate from background pressure changes, that is, the increased pressure drop resulting from the restriction helps elevate pressure signals resulting from a user puff above the background noise, which helps enable detection of a user puff using a single sensor. Locating the pressure sensor immediately downstream of a restriction in this manner thus increases the sensitivity of detection of a user puff.

In use, an aerosol-generating article 200 is inserted into the chamber 2 and the device is actuated. This initiates a usage session. The first heater 3 rapidly heats up to its stand-by operating target temperature, for example a temperature of 170° C. as described above. The user then puffs, or inhales, on the mouthpiece 204 of the article 200. This results in an air flow being drawn through the device air inlet 87, through the flow restriction portion 8, through the second heater 4, then through the article 200, then into the mouth of the user.

The flow restrictor 8 reduces a cross-sectional area of the device air flow path. Thus, as air flows through the flow restrictor 8, the air flow accelerates and reduces in pressure. The pressure drop created by the flow restrictor 8 is sensed by the pressure sensor 7 of the puff detection mechanism and relayed continuously, or at frequent intervals such as every 50 milliseconds, to a controller of the device. When the pressure in the flow restrictor reduces by a significant amount, a puff is detected.

In response to detecting the puff, the controller supplies power to the second heater 4. Air passing through the heater is heated to a temperature of between about 250° C. and 300° C. This heated air then passes through the aerosol-forming substrate 201 of the article 200, boosting the temperature of the aerosol-forming substrate from the stand-by target temperature of 170° C. to an operational target temperature of 250° C. This heats the aerosol-forming substrate 201 to above the aerosolization temperature of the aerosol-forming substrate 201 form an aerosol.

It is noted that the second heater may be activated from initiation of a usage session, in which case the controller may supply greater power to the second heater on detection of a user puff.

When the pressure sensor 7 no longer senses a pressure drop in the air flow path, this may indicate that the puff has ended. Thus, the controller adjusts the power supplied to the second heater 4 to the value it was before the user puff. As the aerosol-forming substrate is no longer receiving a thermal boost via a stream of heated air, the temperature of the aerosol-forming substrate drops again to the stand-by target temperature.

This process is repeated for each of a plurality of puffs during the usage session until the usage session is ended, for example after a predetermined number of puffs have been taken or after a predetermined time duration from initiation of the usage session.

FIG. 5 illustrates a portion of an aerosol-generating device 501 having an alternative air flow path configuration. The device 501 is illustrated in engagement with an aerosol-generating article 200. The device 501 is substantially the same as the device illustrated in FIGS. 1 to 4, and common components have been given the same reference numerals in FIG. 5.

An air flow inlet 587 of the device 501 is defined by an opening into a channel 580 defining an air flow path 506 upstream of the second heater 4. The air inlet 587 is located adjacent to the opening 12 of the chamber 2. The channel 580 extends along the length of the chamber and passes in thermal contact with the first heater 3 before opening into the second heater 4 located upstream of the chamber 2. Air drawn into the air flow path 506 through the inlet 587 passes through an orifice plate 518 and past a pressure sensor 507, before entering the second heater 4 and, thereafter, the chamber 2. The orifice plate 518 forms a restriction in the air flow path 506, causing a detectable pressure drop at the location of the sensor 507 when a user takes a puff.

In use, the device 501 operates in the same manner as the device described above in relation to FIG. 4. Incoming air passing along the channel 580 is heated to some degree by the first heater 3, and thus some thermal energy that may otherwise have been lost to the system is reclaimed in the air flowing through the device and passed to the aerosol-forming substrate 201 of an article 200 located in the chamber 2.

Different aerosol-generating articles may provide different resistance to draw (RTD). This may change the overall RTD of the system (that is the RTD of the combined aerosol-generating device and aerosol-generating article). It may be desirable to tailor the pressure drop caused by the restriction to optimise detection of a puff for a particular system. Thus, it may be desirable to provide a test device on which optimum dimensions of a restriction can be determined and on which a pressure sensor can be calibrated for a specific system.

FIG. 6 illustrates a portion of a test aerosol-generating device 601 engaged with an aerosol-generating article 200. The device 601 is substantially the same as the device illustrated in FIG. 4, and common components have been given the same reference numerals in FIG. 6. Thus, the device 601 comprises a chamber 2 for receiving an article 200. The chamber is heated by a first heater 3. A second heater 4 and a pressure sensor 7 are arranged in an air flow path 6 upstream of the chamber 2. A variable flow restrictor 618 is located upstream of the pressure sensor 7, and a flow meter 630 is located upstream of the variable flow restrictor 618. The variable flow restrictor comprises a screw thread that can be adjusted to vary the cross-sectional area of the air flow path at the restriction. It is noted that many other forms of variable flow restrictor may be used, for example a ball valve, a gate valve, or a butterfly valve. The flow meter is configured to measure actual flow rate and volume through the air flow path when air is drawn through the system. By knowing the actual flow through the system, by means of the flow meter, signals from the pressure sensor can be calibrated. By using a variable restriction, the effect of different pressure drops on sensitivity of the pressure sensor may be assessed. Once dimensions of a suitable restriction have been selected, an aerosol-generating device can be produced with a fixed restriction and without need of a flow meter.

In some specific embodiments, the first heater (maintenance heater) and the second heater (boost heater) may be combined in a single heater assembly. FIG. 7 is a schematic illustration of a heater assembly that may be used in an aerosol-generating device according to an embodiment of the invention. The heater assembly 712 comprises a hollow body portion 714 partially defining a chamber 716 for receiving a portion of an aerosol-generating article. The chamber 716 comprises an open end 718 through which an aerosol-generating article may be inserted into the chamber 716 and a closed end 720 opposite the open end 718. In more detail, the hollow body portion 714 comprises a tubular element 728, which partially defines a cylindrical wall 722 of the chamber 716 that extends between the open end 718 and the closed end 720. The tubular element 728 is arranged so that an aerosol-generating article is received within the tubular element 728 and in direct contact with the tubular element 728 when the aerosol-generating article is inserted into the chamber 716. Advantageously, direct contact between the tubular element 728 and an aerosol-generating article facilitates the transfer of heat from the tubular element 728 to the aerosol-generating article. The tubular element is formed from a thermally conductive material, for example a metallic material such as a stainless steel.

The heater assembly further comprises a body portion 730 that is pervious or permeable to an air flow. In a specific embodiment, the body portion is a porous body portion 730 defining an airflow path 732 through the porous body portion 730. The airflow path 732 is upstream of, and in fluid communication with the chamber 716. The porous body portion 730 comprises a porous plug 734 provided within the tubular element 728.

A first resistance heater 740 is arranged in contact with an outer surface 727 of the hollow body portion 714 of the heater assembly. The first resistance heater is electrically connected to power supply terminals 741, 742 to supply power to the heater 740. The first resistance heater 740 is arranged to provide a maintenance heating to an aerosol-forming substrate positioned within the chamber 716 by maintaining the temperature of the substrate at a stand-by target temperature that is lower than the aerosolization temperature for that substrate.

A second resistance heater 750 is arranged in contact with an outer surface 727 of the porous body portion 730 of the heater assembly. The second resistance heater is electrically connected to power supply terminals 751, 752 to supply power to the heater 750. The second resistance heater is arranged to heat the porous plug 734 and any air flowing therethrough. Air heated in this manner provides a thermal boost to an aerosol-forming substrate positioned within the chamber 716 when a user takes a puff, thereby raising the temperature of the substrate to an operational temperature above the aerosolization temperature for that substrate while the user is taking a puff. It is noted that the same power supply may be used to supply power to both the first and the second resistance heaters. Alternatively, each heater may have a separate power supply.

FIG. 8 illustrates a portion of an aerosol-generating device 800 comprising the heater assembly 712 of FIG. 7. The heater assembly 712 is located within a housing 810. A channel 805 defines an air flow path 806 leading from an air inlet 887 defined in the housing of the device, through the porous plug 734 of the heater assembly 712, and into the chamber 716. An orifice plate 818 is arranged within the air flow path downstream of the inlet providing a restriction, and a pressure sensor 807 is located in the airflow path downstream of the restriction 818.

In use, the device 800 of FIG. 8 functions in the same manner as described above in relation to the device of FIG. 4. That is, when an aerosol-generating is inserted into the chamber 716 and the device is actuated, a usage session is initiated. The first heater 740 heats the aerosol-forming substrate 201 to a stand-by operating target temperature, for example a temperature of 170° C. The user then puffs, or inhales, on the mouthpiece 204 of the article 200. This results in an air flow being drawn through the device air inlet 887, through the orifice plate 818, through the porous plug 734, then through the article 200, then into the mouth of the user. The second heater 750 supplies heat to heat the porous plug 734. When a controller receives signals from the pressure sensor 807 indicating that a user puff is being taken, power is supplied to the second heater 750. Heated air passing through the porous plug 734 raises the temperature of the aerosol-forming substrate to an operational temperature at which an aerosol can be generated.

The heater assembly 712 described in relation to FIG. 7 utilises resistance heaters disposed on the surface of a conductive material. In some specific embodiments, a heater assembly may be manufactured by moulding a conductive, resistance heatable, polymer. Electrodes may then be attached directly to portions of the heater assembly to heat those portions of the heater assembly. An example is illustrated in FIG. 9.

FIG. 9 is a schematic illustration of a heater assembly 912 formed from a conductive and resistively heatable polymer 901. The polymer 901 is a polymeric composite comprising a polymeric matrix and conductive filler particles. In a specific example, the polymer 901 comprises a polymeric material and at least one particulate filler selected from the list consisting of graphite, a graphite-derived material, and hexagonal boron nitride, the filler being dispersed within the polymeric material. The polymeric material forming the matrix in the specific example is polyether ether ketone (PEEK), but could be a liquid crystal polymer (LCP) instead. The polymer 901 comprises the polymeric material in an amount of 27 percent by weight, though this amount could be anywhere between 22 percent and 33 percent. The polymer 901 comprises the filler in an amount of 65 percent by weight, though this could be between anywhere 62 percent and 69 percent. The polymer 901 further comprises an additive, carbon black, dispersed within the polymeric material. The polymer 901 comprises the additive in an amount of 7 percent by weight, though this could be anywhere between 5 percent and 9 percent.

A heating body comprising a polymeric matrix and conductive filler particles of at least one of graphite, a graphite-derived material, and hexagonal boron nitride dispersed within the polymeric matrix is generally easier to manufacture compared to similar heating bodies configured for resistive heating. In particular, the thermoplastic properties of the polymeric matrix may make it possible for the polymer composite to be tailored to be conveniently malleable, such that it lends itself to precise and controlled shaping. Thus, the polymer 901 described is easier to form into elongate, hollow shapes compared with other conductive materials typically used in the heater assemblies of existing aerosol-generating devices. By controlling and adjusting the concentration and distribution of conductive filler particles dispersed within the polymeric matrix, it is advantageously possible to provide a polymeric heating body capable of generating enough heat by resistance heating so as to efficiently heat a solid aerosol-generating substrate of an aerosol-generating article thermally coupled with the heating body. For example, by adjusting the formulation of the polymeric matrix and the degree of dispersion of the conductive filler particles within the polymeric matrix it is possible to control the conductivity of the resulting polymer and, as a consequence, the amount of heat generated resistively by the heater assembly when a voltage is applied to the heating body.

In order to form the heater assembly 912 illustrated in FIG. 9, the resistively heatable polymer 901 is heated and extruded to form a hollow tube. This tube forms an outer portion 920 of the heater assembly 912. Granulated polymer is then placed in one end of the tube and lightly sintered to form a porous plug 934 spanning one end of the tube. Preferably, the granulated polymer particles that are sintered to form the porous plug have a number average particle diameter of less than 800 micrometres, for example between 50 micrometres and 600 micrometres. Preferably, a transverse cross-sectional porosity of the porous plug is greater than 15 percent and less than 45 percent. Preferably, a total pore volume of the porous plug is between 0.5 cubic centimetres and 5 cubic centimetres, for example between 2 cubic centimetres and 3.5 cubic centimetres. Preferably, the porous plug provides a resistance to draw of between 10 mm H₂O and 40 mm H₂O, for example about 15 mm H₂O or about 20 mm H₂O.

The resulting heater assembly 912 has an opening 918 at one end, leading to a chamber 916 defined by inner walls 922.

A first pair of electrodes 941, 942 attached to the heater assembly in the region of the cavity 916 allow a current to be passed through a portion of the heater assembly walls. As the polymer 901 is resistively heatable, the act of passing a current through a portion of the heater assembly causes the heater assembly walls to heat up and supply heat to an aerosol-generating substrate located within the cavity. Thus, the walls of the cavity 930 can act as a first heater to provide a maintenance heating to a substrate located within the cavity.

A second pair of electrodes 951, 952 attached to the heater assembly in the region of the porous plug 934 allow a current to be passed through that portion of the heater assembly walls. These electrodes allow walls of the heater assembly and the porous plug to be resistively heated. Thus, the porous plug 934 can act as a second heater to heat air passing through the porous plug and provide a thermal boost to an aerosol-forming substrate when a user takes a puff.

A heater assembly as described in relation to FIG. 9 may be used as the heater assembly in the device 800 described in relation to FIG. 8.

FIG. 10 illustrates a further specific example of a heater assembly 1012 that may be used in embodiments of the invention. The heater assembly 1012 comprises a hollow body portion 1014 partially defining a chamber 1016 for receiving a portion of an aerosol-generating article 200. The chamber 1016 comprises an open end 1018 through which an aerosol-generating article 200 may be inserted into the chamber 1016 and a closed end 1020 opposite the open end 1018.

In more detail, the hollow body portion 1014 comprises a tubular element 1028, which partially defines a cylindrical wall 1022 of the chamber 1016 that extends between the open end 1018 and the closed end 1020. The tubular element 1028 is arranged so that an aerosol-generating article is received within the tubular element 1028 and in direct contact with the tubular element 1028 when the aerosol-generating article is inserted into the chamber 1016. The tubular element is formed from a ceramic material, for example alumina.

Projections 1019 extending from the internal wall 1022 of the cavity 1016 limit the extent to which an aerosol-generating article may be inserted into the chamber 1016. These projections allow a gap between a distal end of the aerosol-generating article and a porous plug 1034. The gap may be between 1 mm and 5 mm, for example between 1.5 mm and 3 mm. The gap helps to thermally insulate the aerosol-generating article from the porous plug 1034 so that the porous plug only influences the temperature of the article when a user takes a puff.

The heater assembly further comprises a porous body portion 1030 defining an airflow path 1032 through the porous body portion 1030. The airflow path 1032 is upstream of, and in fluid communication with the chamber 1016. The porous body portion 1030 comprises a porous plug 1034 provided within the tubular element 1028.

A first resistance heater 1040 is arranged within the tubular element 1028 at the hollow body portion 1014 of the heater assembly. The first resistance heater is electrically connected to power supply terminals 1041, 1042 to supply power to the heater 1040. The first resistance heater 1040 is arranged to provide a maintenance heating to an aerosol-forming substrate positioned within the chamber 1016 by maintaining the temperature of the substrate at a stand-by target temperature that is lower than the aerosolization temperature for that substrate.

A second resistance heater 1050 is arranged within the tubular element 1028 at the porous body portion 1030 of the heater assembly. The second resistance heater is electrically connected to power supply terminals 1051, 1052 to supply power to the heater 1050. The second resistance heater is arranged to heat the porous plug 1034 and any air flowing therethrough. Air heated in this manner provides a thermal boost to an aerosol-forming substrate positioned within the chamber 1016 when a user takes a puff, thereby raising the temperature of the substrate to an operational temperature above the aerosolization temperature for that substrate while the user is taking a puff.

FIGS. 11 and 12 are schematic illustrations of a further specific example of a heater assembly 1112 that may be used in embodiments of the invention. The heater assembly 1112 is formed from a conductive and resistively heatable polymer 901 formed from a polymeric composite comprising a polymeric matrix and conductive filler particles. The heater assembly 1112 is substantially the same as the heater assembly 912 described in relation to FIG. 9, and similar features have been given the same reference numerals as the assembly of FIG. 9. Projections 1119 may be located within the chamber 916 to provide a spacing between an aerosol-forming substrate inserted into the chamber and the porous plug 934 that defines an end of the chamber.

The resistively heatable polymer 901 of the heater assembly 1112 is heated by a current passed between a first annular contact 1141 disposed at a first end 1121 of the tubular outer portion 920 of the heating assembly and a second annular contact 1142 disposed at a second end 1122 of the tubular outer portion 920. The contacts 1141, 1142 may be copper rings attached to the heating body, for example by mechanical interaction or by an overmoulding process. Conductive adhesives may also be used to attach the contacts, for example HT-carbon adhesive or silver epoxy adhesive may be used. The arrangement of the second annular contact 1142, the tubular outer portion 920 of the heating assembly 112 and the porous plug 934 spanning the second end 1122 of the heater assembly 1112 is illustrated in the end projection of the heater assembly 1112 shown in FIG. 12.

In use, a voltage is applied between the first annular contact 1141 and the second annular contact 1142 causing a current to flow, which resistively heats the outer portion 920 of the heater assembly 1112. Heat from the heater assembly in the region of the cavity may heat an aerosol-forming substrate inserted in the cavity. Heat from the heater assembly in the region of the porous plug 934 may heat the porous plug. When a user takes a puff, incoming air is heated as it passes through the porous plug 934 and provides a thermal boost to the aerosol-forming substrate in the cavity.

FIGS. 13 and 14 illustrate an alternative electrical connection for a heater assembly 1312 formed from a resistively heatable polymer as described above. The heater assembly 1312 may comprise an first, annular, contact 1341 located at a first end 1321 of the heater assembly and a second contact 1342 embedded in the porous plug 934 portion of the heating assembly 1312. The second contact 1342 may comprise a plurality of branches 1343 to spread electrical connection over a wider region of the porous plug 934. Operation of the heating assembly is substantially as described above in relation to FIGS. 11 and 12.

FIGS. 15 and 16 illustrate an alternative electrical connection for a heater assembly 1412 formed from a resistively heatable polymer as described above. Instead of contacts located at opposing ends 1421, 1422 of the heater assembly 1412, the assembly comprises first contact 1441 and second contact 1442 both located at radially opposite portions of the second end 1422 of the assembly. Current passed between the first contact 1441 and the second contact 1442 resistively heats the heater assembly 1412 at the second end 1422 and acts to heat the porous plug 934. Heat generated at the second end 1422 of the heater assembly is transferred towards the first end 1421 of the heater assembly 1412 by conduction. Thus, heat transferred towards the first end 1421 of the heater assembly may be used to supply a maintenance heating to an aerosol-forming substrate located within the cavity 916. The electrical configuration shown in FIGS. 15 and 16 may allow the porous plug to be heated to a greater temperature than portions of the heater assembly defining the chamber 916.

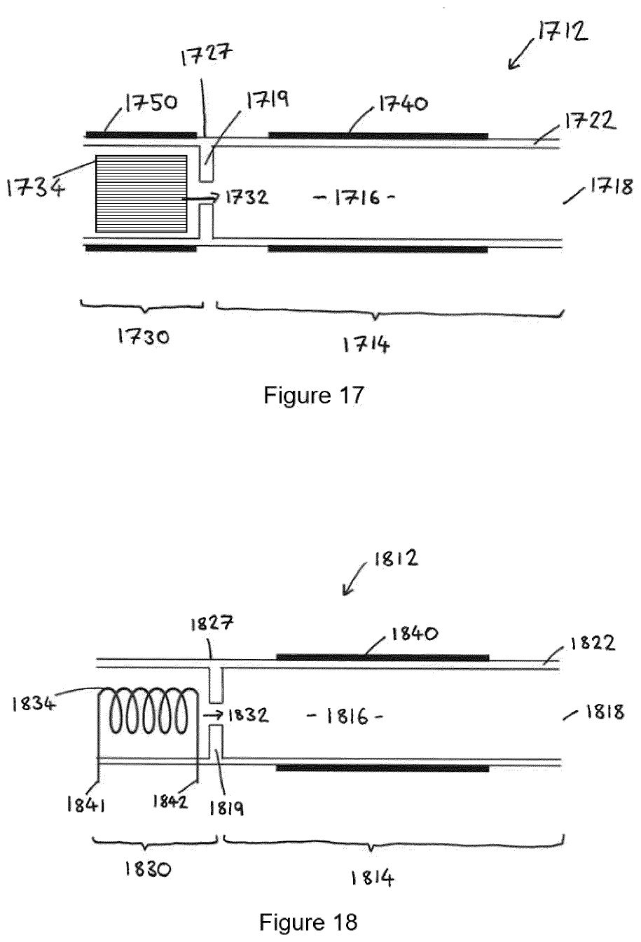

FIG. 18 is a schematic illustration of a heater assembly that may be used in an aerosol-generating device according to an embodiment of the invention. The heater assembly 1812 defines a first body portion 1814 comprising a chamber 1816 for receiving a portion of an aerosol-generating article. The chamber 1816 comprises an open end 1818 through which an aerosol-generating article may be inserted into the chamber 1816. The heater assembly 1812 defines a thin cylindrical wall 1822. The thin cylindrical wall is formed from a thermally conductive material, for example a ceramic material such as zirconia or alumina.

The heater assembly further comprises a second body portion 1830. The second body portion 1830 defines an airflow path 1832 upstream of, and in fluid communication with the chamber 1816. In this specific embodiment, the second body portion 1830 comprises a resistive heating coil 1834.

Projections 1819 extending from the internal wall of the cavity 1816 limit the extent to which an aerosol-generating article may be inserted into the chamber 1816. These projections allow a gap between a distal end of the aerosol-generating article and the resistive heating coil 1834.

A first resistance heater 1840 is arranged in contact with an outer surface 1827 of first body portion 1814. The first resistance heater 1840 is arranged to provide a maintenance heating to an aerosol-forming substrate positioned within the chamber 1816 by maintaining the temperature of the substrate at a stand-by target temperature that is lower than the aerosolization temperature for that substrate.

The resistive heating coil 1834 is arranged within the second body portion 1830 to heat any air flow through the second body portion 1830. Air heated in this manner provides a thermal boost to an aerosol-forming substrate positioned within the chamber 1816 when a user takes a puff, thereby raising the temperature of the substrate to an operational temperature above the aerosolization temperature for that substrate while the user is taking a puff. A pair of electrodes 1841, 1842 attached to the resistive heating coil 1834 allow an electric current to be passed through the resistive heating coil 1834. It is noted that the same power supply may be used to supply power to both the first resistance heater 1840 and the resistive heating coil 1834. Alternatively, each heater may have a separate power supply.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10 percent (10%) of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-13. (canceled)

14. An aerosol-generating device configured to generate an aerosol from an aerosol-forming substrate,
wherein the aerosol-generating device defines a cavity configured to receive at least a portion of the aerosol-forming substrate, and an air flow path upstream of the cavity configured for a user to draw air through the aerosol-generating device, the air flow path fluidically connecting the cavity with an external environment,
wherein the aerosol-generating device comprises:
a first heating portion located at the cavity, and
a second heating portion located in thermal contact with the air flow path upstream of the cavity,
wherein the aerosol-generating device is configured to
heat the aerosol-forming substrate during a usage session with reference to two different target temperatures, a stand-by target temperature and an operational target temperature, the stand-by target temperature being a temperature greater than room temperature and the operational target temperature being higher than the stand-by target temperature,
heat the aerosol-forming substrate to the stand-by target temperature during the usage session, and
heat the aerosol-forming substrate from the stand-by target temperature to the operational target temperature during a user puff undertaken during the usage session, the aerosol-forming substrate being allowed to cool from the operational target temperature after the end of the user puff,
wherein the first heating portion is configured to supply energy to heat the aerosol-forming substrate to the stand-by target temperature and the second heating portion is configured to heat the aerosol-forming substrate to the operational target temperature during user puffs.

15. The aerosol-generating device according to claim 14, wherein the first heating portion comprises a heater arranged in contact with walls of the cavity.

16. The aerosol-generating device according to claim 15, wherein the first heating portion further comprises a flexible heater arranged in contact with an inner surface of the cavity or an outer surface of the cavity.

17. The aerosol-generating device according to claim 15, wherein the first heating portion further comprises a polyimide flexible heater arranged in contact with an inner wall of the cavity or an outer wall of the cavity.

18. The aerosol-generating device according to claim 14, wherein the second heating portion comprises an inductive heating arrangement.

19. The aerosol-generating device according to claim 14, wherein second heating portion comprises an inductor configured to heat a susceptor located within the air flow path upstream of the cavity.

20. The aerosol-generating device according to claim 14, wherein the second heating portion comprises a porous body, the air flow path being defined through the porous body.

21. The aerosol-generating device according to claim 14, wherein the second heating portion comprises a heating body configured for Joule heating, the heating body including a polymer composite comprising a polymeric matrix and a plurality of conductive particles dispersed within the polymer matrix.

22. The aerosol-generating device according to claim 14, wherein the first heating portion is formed by a cylindrical or tubular element that is made of resistive material, and the second heating portion is formed as a porous body inside an end of the cylindrical or tubular element opposite an open end configured to receive the aerosol-forming substrate, cavities of the porous body forming the airflow path.

23. The aerosol-generating device according to claim 14, wherein the first heating portion is formed by a cylindrical or tubular element that is made of resistive material, and the second heating portion is formed as an air-permeable body having a plurality of tubular or meandering structures inside a portion of the cylindrical or tubular element opposite an open end configured to receive the aerosol-forming substrate, tubular or meandering structures of the air-permeable body forming the airflow path.

24. The aerosol-generating device according to claim 14, wherein the first and the second heating portions are formed as a unitary structure of a same electrically resistive heater material.

25. The aerosol-generating device according to claim 21, wherein the polymer composite comprises a polymeric matrix and a plurality of non-metallic conductive particles dispersed within the polymer matrix.

26. The aerosol-generating device according to claim 21, wherein the polymer composite comprises a polymeric matrix and a plurality of carbon particles or boron nitride particles dispersed within the polymer matrix.

27. The aerosol-generating device according to claim 22, wherein the polymeric matrix comprises at least one of polyether ether ketone (PEEK) and a liquid crystal polymer (LCP).

28. The aerosol-generating device according to claim 14,
wherein the aerosol-generating device is further configured to generate the aerosol from the aerosol-forming substrate during the usage session, and
wherein both the first heating portion and the second heating portion are actuated at a start of the usage session, the first heating portion being configured to directly heat the aerosol-forming substrate received in the cavity and the second heating portion configured to heat air drawn into the air flow path by a user puff.

29. The aerosol-generating device according to claim 14, wherein the aerosol-generating device is further configured detect a user puff.

30. The aerosol-generating device according to claim 29,
wherein power is only supplied to the second heating portion during the user puff, or
wherein power supplied to the second heating portion is increased during the user puff.
